(19) United States
(12) Patent Application Publication
(10) Pub. No.: US 2006/0153380 A1
(43) Pub. Date: Jul. 13, 2006

(54) Personal cryptoprotective complex

(76) Inventor: Dmitry Alexandrovich Gertner, Syktyvkar (RU)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 10/518,605

(22) PCT Filed: Jun. 18, 2003
(86) PCT No.: PCT/RU03/00266

§ 371 Date: Jul. 21, 2005

(30) Foreign Application Priority Data
Jun. 18, 2002 (RU) 2002116399

(51) Int. Cl. H04N 7/167

(52) U.S. Cl. 380/221

(57) ABSTRACT

The invention relates to information protection and user identification. The technical result consists in functionality enhancement including: information encryption and decryption; electronic document authentication using an electronic digital signature; protection of electronic documents against copying, exchange of copy-protected electronic documents; settlements by means of electronic payment facilities; protection of software and databases against unauthorized copying. The inventive personal cryptoprotective complex comprises a code-carrying medium in the form of a cassette for protection of cryptographic data and a terminal device for communications with peripheral devices such as a personal computer, a telephone and a card reader. The cassettes for personal cryptoprotective complexes are embodied such that they have a unified architecture, common software and an identical secret mother code. A protective sheath of the cassette has light-reflective surfaces. A program for monitoring the integrity of the protective sheath destroys the mother code in case of an authorized access. A data processing program checks the inputted open information for presence of service symbols therein which are used as a most important tool for carrying out different cryptographic operations. Individual data of a user, including the electronic digital signature thereof, is recorded in a ROM. The inventive cryptoprotective complex comprises a user identification device in the form of an identification wristband that stores single-use access passwords.

### FIELD OF THE INVENTION

The invention relates to provision of information protection and is intended for storage of access codes, keys and passwords, for user identification, for safe information exchange on open communication channels, for safe realization of various settlements in electronic money and their substitutes, for conclusion of electronic transactions and creation of electronic documents confirmed with electronic signatures without use of asymmetric keys, for protection of computer programs and databases against non-authorized copying, for safe transmission and exchange of electronic documents with protection against copying.

### BACKGROUND OF THE INVENTION

Devices for user identification by means of a plastic card containing a microchip and an access code inputted by a user for access to protected objects are widely known. Their disadvantage is the necessity each time to input the access code, and when the card is intended for access to various objects which were not connected to each other, it is necessary for a user to remember some various access codes.

Also known is a device for safe information storage on a chip in which a microprocessor, buses and a memory are combined. The disadvantage of such a design is that one can scan information from a chip using a special electronic probe. The attacks based on breakup of data storage hardware by a laser beam and on a method of ion analysis also may be used.

Systems for encryption by means of asymmetric keys, based on use of confidential and public keys, and also on difficulty of inversion of unilateral functions, are known. The disadvantage of such systems is that the volume of a cryptogram considerably exceeds the volume of initial information. Assigned to the disadvantages also may be a constantly decreasing cryptoresistance of the present systems owing to creation of high-speed computers united in a network, and the mathematical methods facilitating the decryption process, while increase in a length of a key to improve the cryptoresistance of an algorithm results in delay of encryption and decryption processes and requires consumption of significant computing facilities.

Systems intended for encryption by means of symmetrical keys and based on methods of repeated replacement and permutation of information items are known. The disadvantage of such systems is the necessity of secret key exchange before a cryptoprotective communication session, which makes their interception possible. Besides, knowing a fragment of initial information and its cryptogram, it is easy to calculate a key, while increase in a length of a key to improve the cryptoresistance of an algorithm will result in delay of encryption and decryption processes. Another substantial disadvantage of such encryption system is that if more than two users have a key, all owners of the key may decrypt information designed to one user.

Known is a method for authentication of electronic documents by their hashing and encrypting a hashing value by means of a secret key of a person signed a document, said key being decrypted by an open key of the present person. The disadvantage of such method consists in that, in order to identify an electronic digital signature, a user should know that the open key really belongs to the person on behalf of whom the document was signed. Besides, in order to identify a date of signing the document, it is necessary to carry out certification of the date through special certification centers by means of Internet. Application of the electronic signature requires organization of a trust certifying center.

Known is a device that is a smart card comprising a microchip used for settlements by carrying out transactions with use of communication links. The disadvantages of the present device and the settlement method used thereon are: the necessity for a bank to take part in all operations of a smart card user permanently, that requires the presence of a network of terminals connected to communication links; a user should each time input his or her PIN code, and the user has to report said PIN code to a seller for calculations through the Internet. Users cannot make settlements among themselves directly. The bank may trace all operations of the smart card user and his or her location at the moment of execution of operation.

Known is a method of using asymmetric encryption systems for settlements in electronic cash: electronic banknotes and coins. The disadvantage of the present method is that the same electronic banknote or coin may be spent several times. The electronic coin may circulate a limited quantity of times because data of all of its former owners is recorded in view of safety. Banks limit use of the sum of electronic cash on one smart card in view of safety as well.

Known is a device that is an electronic key containing microchip in which an access code for using a computer program is recorded, said key being intended for protection of the program against illegal copying. The disadvantage of the present device is that the electronic key is intended only for one program; besides, there are methods for creating emulators of an electronic key, which makes it possible to copy computer programs in a non-authorized way.

The closest similar prior art solution is a system of distributed keys based on intellectual cryptographic cards known as PC Cards including a protective brand, a microprocessor and a nonvolatile memory in which keys are recorded, unique for each card. The microprocessor carries out encryption and decryption according to an algorithm recorded in the memory of the card. To carry out cryptographic operations, the card is inserted in a special connector in a computer whereupon a user inputs a password and identification data that give access to a card. Then users make an exchange of open keys and develop a temporary symmetrical key of a session, which may be a dynamic key and using which the encryption and decryption of information is carried out. The fundamental disadvantage of the present systems consists in that the card cannot determine an object with which the cryptoprotective communication is established, because a user may reproduce algorithm of operation of PC cards on a common computer, and the user can use a set of random numbers of a necessary size as keys, since keys recorded in PC cards of one user are not known to PC cards of other users, and it is impossible to establish the substitution of keys. Because of the present disadvantage, PC cards cannot be used for fulfillment of various functions based on trust to a source of information. Besides, such cards as PC cards have no enough reliable physical protection against scanning information from a chip.

### DISCLOSURE OF THE INVENTION

It is a problem of the present invention to provide a multifunctional universal cryptoprotective complex convenient in application, inexpensive in manufacture, having a high degree of physical and logic protection and a high speed of data processing. The technical result accomplished by the invention consists in expansion of functionalities of the cryptoprotective complex which provides effective fulfillment of such functions as: encryption and decryption of information during its transmission from one user to another; encryption and decryption of electronic documents using a decryption password with the possibility of decryption by any user of a personal cryptoprotective device, who knows a decryption password; encryption and decryption of electronic documents with protection against obtrusion of false information and modification making; authentication of electronic documents by signing with an electronic digital signature of a user; identification of a user; protection of electronic documents against copying by analogy to documents on a paper medium having protection against the counterfeit; the possibility of a simultaneous exchange of copy-protected electronic documents; the possibility for various users to sign an electronic document with their electronic signatures simultaneously; settlements in electronic cash and electronic bills between different users; the possibility for converting electronic cash and electronic bills into electronic money of various payment systems; protection of computer programs and databases against non-authorized copying.

Said results according to the invention are accomplished by a combination of devices and methods combined in a personal cryptoprotective complex consisting of a code-carrying medium that is a cassette using which cryptographic information protection is carried out, and a terminal device by means of which communication of the cassette with the outside world is carried out. The cassette has an input/output port for open information and an input/output port for encrypted information that is connected by a user to the terminal device with similar ports. The terminal device may be connected to a personal computer, to a telephone, to a card reader. One cassette is connected to other cassette by means of terminal devices and a communication link through input/output port for encrypted information. Information from and for a user is transmitted through the input/output port for open information, respectively.

Cassettes of all personal cryptoprotective complexes have a unified architecture, common software and an identical secret mother code that is a set of random numbers (M1, M2, . . . , MN) recorded into said devices in a protected way excluding the possibility of copying the mother code onto other media and variations of a program code of software. The software and the mother code should be recorded to a memory of cassettes by special recorders that operate in the off-line mode and cannot be accessed from the outside, and the mother code being the basis to establish a cryptoprotective session should be generated using a hardware generator of random numbers directly in a central recorder. The software is recorded to a ROM of the cassette, and the mother code is recorded to a volatile memory such as CMOS powered from a built-in accumulator battery. Powered from the present battery are also a built-in real-time non-adjustable clock playing an important role in a number of operations, and a protective sheath into which the cassette is packed and which prevents extraction of information from the cassette, said information containing data of the mother code.

The protective sheath consists of an external casing sheath, an external light-reflecting surface, an internal light-reflecting surface, and a transparent layer located between the light-reflecting surfaces. The two light-reflecting surfaces also face each other. There are a light-emitting diode and several photocells on internal light-reflecting surfaces. A program for testing integrity of the protective sheath, as included in the software, tests the supply of power pulses from the accumulator battery to the light-emitting diode and the reception of power-information pulses from each photocell, and when characteristics of the power-information pulses vary, said program destructs the mother code. To execute operations, the cassette includes a microprocessor, a RAM, a random-number generator. For recording information, the cassette is provided with a multiple writable PROM. The structure of the software recorded in the ROM includes an encryption/decryption program, an information-processing program, and an individual number of a personal cryptoprotective complex. The feature of the encryption/decryption program is that the knowledge of initial and encrypted information does not entail a representation about a key to be used, that is, a mother code, and any information is encrypted using at least one random number generated before the beginning of encryption by the built-in random-number generator. The feature of the information processing program consists in that the program checks an incoming open information for presence of certain bit sets—so-called service symbols—therein, and prevents inclusion of said symbols into a decrypted electronic documents at the presence of said symbols in a falsified electronic document. The inclusion of service symbols in the encrypted electronic document is exclusively a prerogative of the information-processing program. Service symbols are the major instrument in fulfillment of various cryptographic operations that allow determination of service information in the electronic document. Besides, functions of the information-processing program are closed for a user, therefore, user's commands incorrect from the viewpoint of the program are ignored, while the commands entered in a structure of service information are always received for execution by the program. Recorded in the ROM are also personal data of a user, including his or her electronic digital signature. The present record is made after purchase of a personal cryptoprotective complex by the user, wherein this record is made by an official registering clerk with simultaneous registration of this information, including an individual number of a personal cryptoprotective complex, to an open database.

Further, the structure of the personal cryptoprotective complex includes a user identification device—an identification wristband equipped with latches having fixation sensors, a lead for connection to the terminal device, and a device for automatic replacement of the accumulator. The identification wristband serves for storage of single-use access passwords that are automatically deleted in removal of the wristband, and provides convenient and fast identification of a user when he or she fulfils cryptoprotective operations.

### BRIEF DESCRIPTION OF THE DRAWINGS

The disclosed group of inventions will now be explained with reference to drawings, in which:

FIG. 1 is an personal cryptoprotective complex;

FIG. 2 is a diagram of a cassette arrangement of the personal cryptoprotective complex;

FIG. 3 is a functional diagram of a protective sheath;

FIG. 4 is a functional diagram for establishment of a cryptoprotective session:

FIG. 4, a), shows the exchange of random numbers Z and Z*;

FIG. 4, b), shows the record of random numbers Z and Z* in a RAM;

FIG. 4, c), shows the derivation of a resulting number X from the numbers Z and Z*;

FIG. 4, d), shows the derivation of a dynamically transformable daughter code from a number X and numbers Mₙ;

FIG. 4, e) shows the synchronous transformation of the dynamically transformable daughter code in personal cryptoprotective complexes of the two users, and also the encryption, transmission, and decryption of information;

FIG. 5 is a functional diagram for transmission of an encrypted message:

FIG. 5, a) shows a user A who inputs an individual number “I” of a personal cryptoprotective complex (ICPC) of an addressee to own ICPC;

FIG. 5, b), shows the derivation of a resulting number X from numbers Z and I;

FIG. 5, c), shows the user A who encrypts and sends an electronic letter together with the number Z;

FIG. 5, d) shows the addressee who inputs the received number Z to own ICPC and derives the resulting number X using own number I;

FIG. 5, e), shows the addressee who inputs the decrypted electronic letter and obtains its original text;

FIG. 6 is a functional diagram for generating an electronic document with a decryption password:

FIG. 6, a), shows the generation of the electronic document with the decryption password;

FIG. 6, b) shows the input of a command to decrypt the electronic document;

FIG. 6, c), shows the decryption of service information of the electronic document and the comparison of decryption passwords;

FIG. 6, d) shows the decryption of the electronic document and the output of the initial text to a user;

FIG. 7 is a functional diagram for generation of an electronic document where service information presents, and for protection against obtrusion of false information:

FIG. 7, a), shows the generation of the electronic document with service information;

FIG. 7, b) shows the recognition of service information by means of service symbols in decryption of the electronic document, and the output of service information together with service symbols to a user;

FIG. 7, c), shows the falsification of the electronic document by inclusion of service information and service symbols in the text before the encryption;

FIG. 7, d) shows the recognition and removal of service symbols together with the falsified service information from the text in decryption of the electronic document;

FIG. 8 is a functional diagram for generation of an electronic document where an electronic digital signature of an ICPC user presents:

FIG. 8, a), shows the ICPC that outputs a user identification request in response to a user's command to sign the electronic document;

FIG. 8, b), shows the input of the electronic document automatically added with an electronic signature of a user, a signing time and date and an individual number of a user's ICPC, after input of user identification data;

FIG. 8, c), shows the output of the electronic signature to the user after decryption of the electronic document, said signature including the signing date and time and the individual number of the user's ICPC together with service symbols that allow authentication of the electronic signature in the present electronic document;

FIG. 9 is a functional diagram for three-step transmission of the electronic document with protection against copying:

FIG. 9, a), shows the transmission of the electronic document from one ICPC to another, wherein the electronic document is disabled in the two ICPCs for a specified time period T1;

FIG. 9, b), shows the sending of an electronic-document-loading acknowledgement password in response to the reception of the electronic document, wherein an electronic document disabling time in the two ICPCs is changed for T2;

FIG. 9, c), shows the sending an electronic-document-transmission acknowledgement password in response to the received electronic-document-loading acknowledgement password, wherein the disabled electronic document in a sender's ICPC is deleted from the memory, and the electronic document in a recipient's ICPC is enabled;

FIG. 10 shows a functional diagram for protection of a computer program against copying:

FIG. 10, a) shows the transmission of a decryption password from one ICPC to another, wherein a decryption password is disabled in the two ICPCs for a specified time period T1;

FIG. 10, b), shows the sending of a decryption-password-loading acknowledgement password in response to the reception of the decryption password, wherein a decryption password disabling time in the two ICPCs is changed for T2;

FIG. 10, c) shows the sending of a decryption-password-transmission acknowledgement password in response to the received decryption-password-loading acknowledgement password, wherein the disabled decryption password in a sender's ICPC is deleted from the memory, and the decryption password in a recipient's ICPC is enabled;

FIG. 10, d), shows the processing of a computer program using the enabled decryption password;

FIG. 11 is a functional diagram for transmission of a decryption password for a computer program on an independent medium:

FIG. 11, a), shows the input of a command and information to record a password onto the independent medium into a ICPC in order to perform the subsequent transmission to another ICPC;

FIG. 11, b) shows the transmission of the password in the encrypted form to the independent medium, and the automatic deletion of said password from a memory of the ICPC;

FIG. 11, c) shows the sending of the encrypted password to a recipient's ICPC where collation with a current date and an individual number of the ICPC is made, and in case of positive result, the decrypted password is recorded to the PROM, but without a right to transmit before the expiration of a date indicated in service information;

FIG. 11, d) shows that the decryption password can be transmitted to another user under the same scheme after the expiration of the date indicated in service information;

FIG. 12 shows a functional diagram for simultaneous exchange of copy-protected electronic documents:

FIG. 12, a) shows that, before exchange of copy-protected electronic documents, one of users inputs a command of simultaneous exchange of electronic documents, then transmission of electronic documents from one ICPC in another is made, wherein electronic documents are disabled in the two ICPCs for a specified time period T1;

FIG. 12, b), shows the sending of an electronic-document-loading acknowledgement password in response to the reception of the electronic document, wherein an electronic document disabling time in the two ICPCs is changed for T2, and besides, users are able to see the text of the disabled electronic documents;

FIG. 12, c), shows that the user inputs an electronic-document-transmission acknowledgement command whereupon an acknowledgement signal is sent to an ICPC of another user;

FIG. 12, d), shows that after the exchange of acknowledgement signals, the synchronization according to a last signal and the simultaneous exchange of electronic-document-transmission acknowledgement passwords are carried out, wherein the disabled electronic document in a sender's ICPC of is deleted from a memory, and the electronic document in a recipient's ICPC is enabled;

FIG. 13 shows a functional diagram for protection of information against listening in open communication links:

FIG. 13, a), is a diagram for counteraction to passive listening:

To generate a single-use key of a communication session, a user A and an outside user should make an exchange of random numbers Z and Z*. An eavesdropping user cannot decrypt intercepted information since his or her cassette cannot generate the same single-use key of the communication session from intercepted numbers Z and Z* because for that it is impossible to satisfy the following condition: one of numbers Z or Z* should be received by own random-number generator in the cassette of the user.

FIG. 13, b, is a diagram for counteraction to active listening:

To generate a single-use key of a communication session, a user A and an outside user should exchange random numbers Z and Z*. In this diagram that illustrates the information eavesdropping between users, an eavesdropping user uses two cassettes to establish an imaginary communication session using two single-use keys ZA and Z*B and to receive decrypted information within a distance between the cassettes. There are two simple methods for detecting active listening to counteract to the present eavesdropping:

1) After the exchange of random numbers in cassettes of users, protected-communication-session-establishment acknowledgement passwords are generated, and these passwords may be expressed in the verbal form for convenience. To be convinced of absence of active listening, users should inform each other about these passwords, and in case of their full coincidence, absence of the information listening on a communication link is ensured.

2) An exchange of electronic visiting cards of users; the user A can receive an electronic visiting card of the outside user and vice versa, respectively, only at absence of active listening.

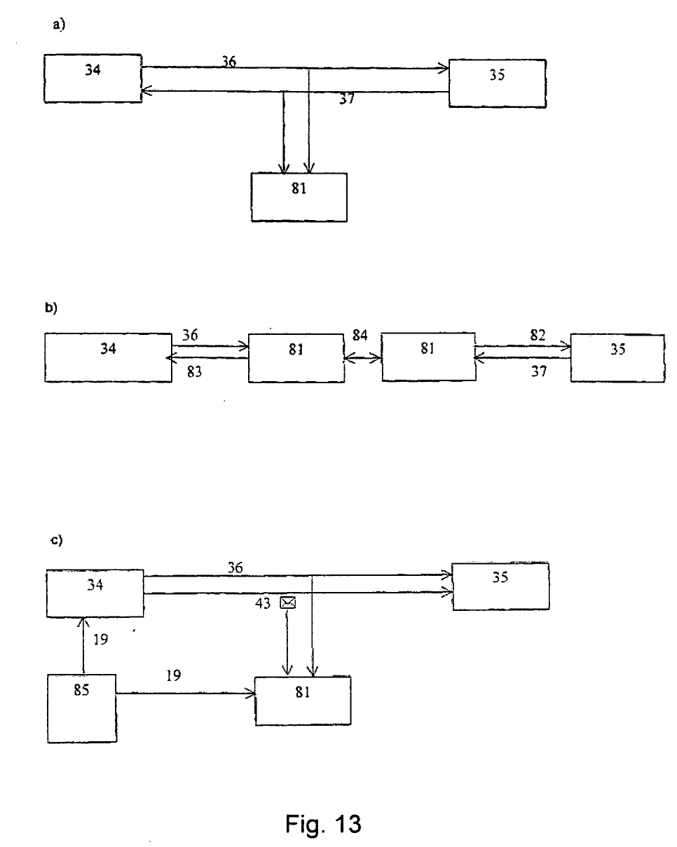

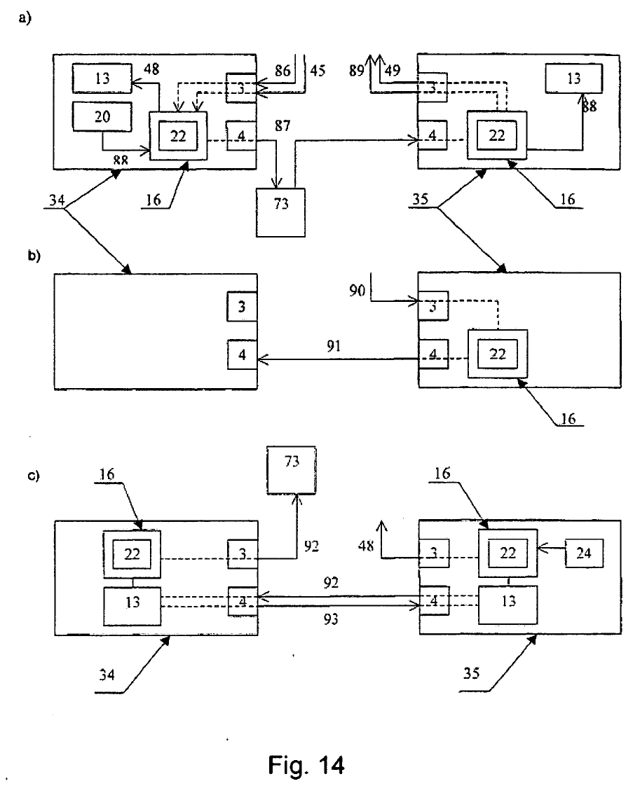

FIG. 13, c), is a diagram for decryption of an electronic letter:

To generate a single-use key for encryption of the electronic letter, the user A uses an individual number of the outside user's cassette and a random number that he or she sends together with the encrypted electronic letter. An eavesdropping user cannot decrypt information in the encrypted electronic letter since his or her cassette can not develop the same single-use decryption key from intercepted numbers Z and I because for that it is impossible to satisfy the following condition: the number I should be an individual number of the user's cassette.

FIG. 14 is a functional diagram for transmission of an electronic letter at notice:

FIG. 14, a) shows generation, sending and reception of the electronic letter at notice in process of a cryptoprotective communication session;

FIG. 14, b), shows that a recipient of the electronic letter at notice generates the notice and sends an appropriate signal to a sender;

FIG. 14, c), shows that users simultaneously send the decryption password to each other in response to the notice of reception of the present letter.

### THE PREFERRED EMBODIMENT OF THE INVENTION

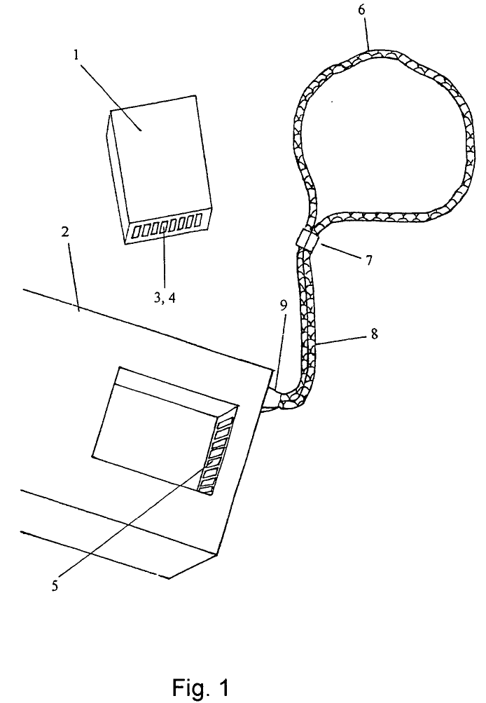

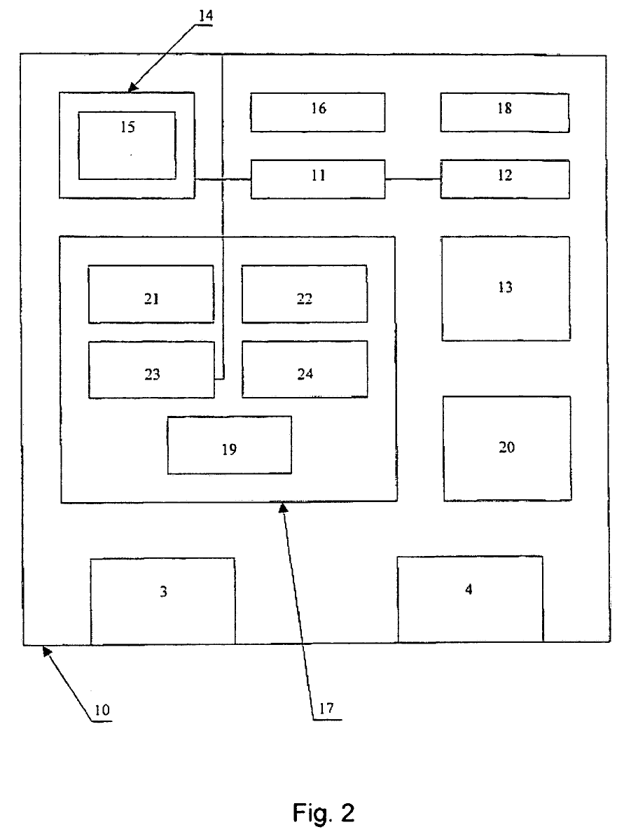

The personal cryptoprotective complex formed in accordance with the invention operates as follows. A user connects a cassette 1 (FIG. 1) to a terminal 2 also activates it by supplying a work starting signal. The activated cassette outputs a user access right request to the user. By a terminal device 2, the user inputs his or her identification data collated by the cassette with data earlier inputted by the user and stored in a PROM 13 (FIG. 2). In case of coincidence of the data, the cassette continues operation. To simplify and accelerate the user identification procedure during the further work in execution of cryptoprotective operations, the user would connect an identification wristband 6 to fixation sensors by means of a lead 8, said wristband being worn on a hand of the user be means of latches 7. After the first successful identification of the user, the cassette checks presence of the connected identification wristband, and at its detection, generates several single-use random passwords while keeping them simultaneously in the PROM 13 of the cassette and in a PROM of the identification wristband 6. Before each operation that requires to check the user access right, the cassette requests the identification wristband for one of single-use passwords, receives a password, collates it with passwords stored in the PROM 13, and at the coincidence of the passwords considers the check of access to be successful. At the same time, the used single-use password is deleted from the memories of the cassette and the identification wristband. At removal of the wristband from the user hand, the fixation sensors of the latches 7 supply a signal to a microprocessor of the identification wristband, and then automatic deletion of all unused passwords from the memory of the wristband is made. In addition, for convenience of the user, the identification wristband 6 and the terminal device 2 may be provided with a wireless interface for interfacing with a wireless data transmission channel. If the identification wristband comprises an accumulator, its replacement may take place during connection of the lead 8 to the terminal 2 by means of an automatic accumulator replacement device 9. The user can also use the identification wristband for access to objects provided with special electronic locks in which single-use access passwords are stored. At the same time, the single-use access passwords may be received by generators of pseudo-random numbers located in a personal cryptoprotective complex of a user and in an electronic lock of an object to be accessed, said generators operating in accordance with a similar program and developing identical single-use access passwords.

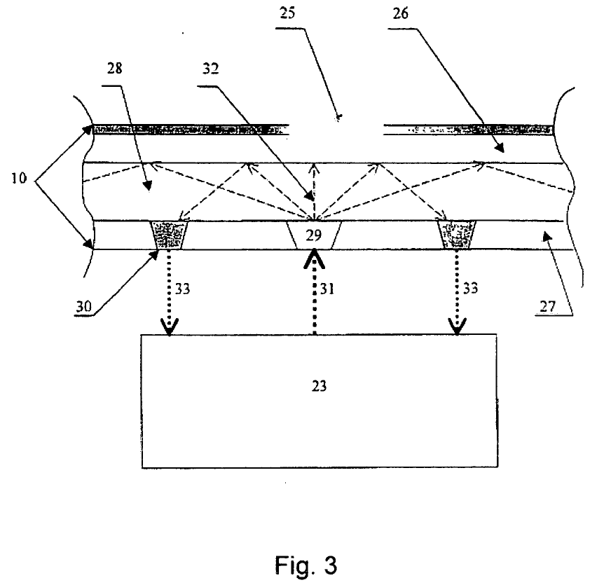

Since operations executed by the cassette require the strengthened protection, then, the cassette is provided with a microprocessor 16 capable of suppressing and masking self-microradiations and creating false microradiations. The microprocessor 16 comprises additional parallel paths to supply signals compensating the microradiations of own signals of the microprocessor, and a generator for generating false microradiations in a frequency band of self-microradiations of the microprocessor. Besides, the cassette 1 is packed into a protective sheath 10 that prevents withdrawal of information from a memory 14 of the cassette. Recorded into the CMOS-type memory 14 is a mother code 15 being the basis to carry out encryption and decryption of all information. Damage of the protective sheath 10 results in destruction of the mother code 15. The present protection operates as follows. An accumulator battery 11 supplies power pulses 31 (FIG. 3) to a light-emitting diode 29, the dosage and periodicity of said pulses being monitored by a program of a protective sheath integrity monitor unit 23. The light-emitting diode 29 generates quanta of light power 32 which, being reflected from light-reflecting surfaces 26 and 27, are distributed through a transparent layer 28 around of the cassette within the protective sheath. Photocells 30 located in various places on the light-reflecting surface 27 absorb quanta of light power 32 and convert them into power-information pulses that are metered and compared to reference values using the program of the protective sheath integrity monitor unit 23. If at least one of light-reflecting surfaces will be damaged, values of the power-information pulses will vary considerably. Such a variation will be estimated by the program of the protective sheath integrity monitor unit as destruction of the protective sheath, and the program will give a command to delete the mother code 15 from the memory 14. In doing so, other information will be stored in the memory of the cassette.

The basic operation executed by the cassette of the personal cryptoprotective complex is the operation of information encryption/decryption. The present operation is executed according to an algorithm incorporated in an encryption/decryption program 21 recorded in a ROM 17. Keys being the basis to carry out the encryption/decryption are a mother code 15 consisting of a set of random numbers (M1, M2, . . . , MN), and a temporary key consisting of at least one random number Z produced by a built-in random-number generator 20. The encryption and decryption with use of personal cryptoprotective complexes includes the following steps to be realized in each of personal cryptoprotective complexes:

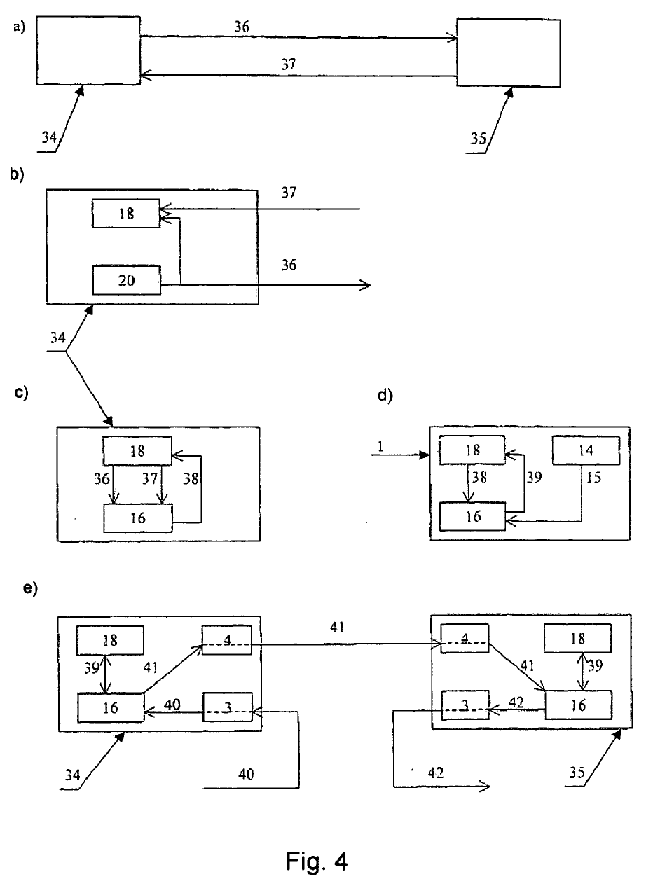

1) connecting, by at least two users, their personal cryptoprotective complexes 34 and 35 (FIG. 4) to a communication link and establishing, by said users, a number of cryptoprotective session participants;

2) producing a random number Z 36 in the personal cryptoprotective complex 34 and a random number Z* 37 in the personal cryptoprotective complex 35, and storing the present numbers in a random access memory 18;

3) exchanging, through a communication link, data of the produced random numbers Z and Z* between said personal cryptoprotective complexes to establish a time moment of starting the generation of a single-use key of a communication session;

4) synchronous generating a single-use key X 38 of the communication session by reading the stored random number Z 36 out of the random access memory, executing a predetermined arithmetic operation on the random number Z 36 read out of the random access memory and the random number Z* 37 received from another user cryptoprotective device, to derive a resulting number X, and storing the resulting number X in the random access memories of the two devices;

5) synchronous generating a dynamically transformable daughter code in the individual cyrptoprotective complexes on the basis of the mother code and the single-use key of the communication session;

6) inputting and dividing initial transmitted information 40 into packets of a determined size, and encrypting the packets with use of the dynamically transformable daughter code;

7) transmitting the encrypted packets of information 41 to at least one other personal cryptoprotective complex;

8) receiving the encrypted packets of information 41 in said at least one other personal cryptoprotective complex;

9) decrypting the received encrypted packets with use of the dynamically transformable daughter code;

10) combining the decrypted packets into the initial information, and outputting information 42 to a user;

wherein steps (5)-(10) are repeated to transmit information in a reverse direction during the same communication session.

The time moment of starting the generation of the single-use key X 38 of the communication session is established according to the moment of transmitting and receiving data corresponding to a last number from said random numbers exchanged through the communication link at the step (3).

The transformation of the dynamic daughter code 39 is synchronized according to the moment of transmitting and receiving each of information packets.

Simultaneously with establishment of a daughter communication session, a single-use password of protective-communication-session acknowledgement is generated in each of personal cryptoprotective complexes that coincides at the present participants of the communication session and is used to make sure of establishment of the protected communication session (FIG. 13, b). In realization of the duplex communication using the personal cryptoprotective complexes 34 and 35, two dynamically transformed daughter codes are synchronously generated in each of them on the basis of the mother code and the single-use key of the communication session. If the first dynamically transformable daughter code for one of personal cryptoprotective complexes is used for encryption of information, then, said dynamically transformable daughter code for another personal cryptoprotective complex is used for decryption of information and it is accordingly considered to be a second dynamically transformable daughter code. At the same time, the transformation of the first dynamically transformable daughter code at the steps (6) and (9) is synchronized according to the moment of transmitting each of information packets, and the transformation at the steps (6) and (9) for the second dynamically transformable daughter code is synchronized according to the moment of receiving each of information packets, thus, the synchronization of each pair of dynamic transformable daughter codes is carried out irrespective of other pair.

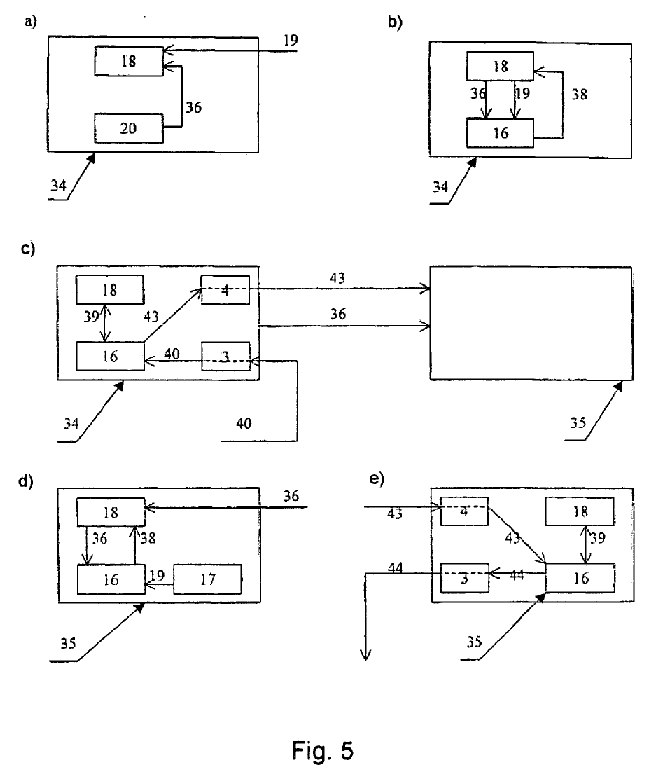

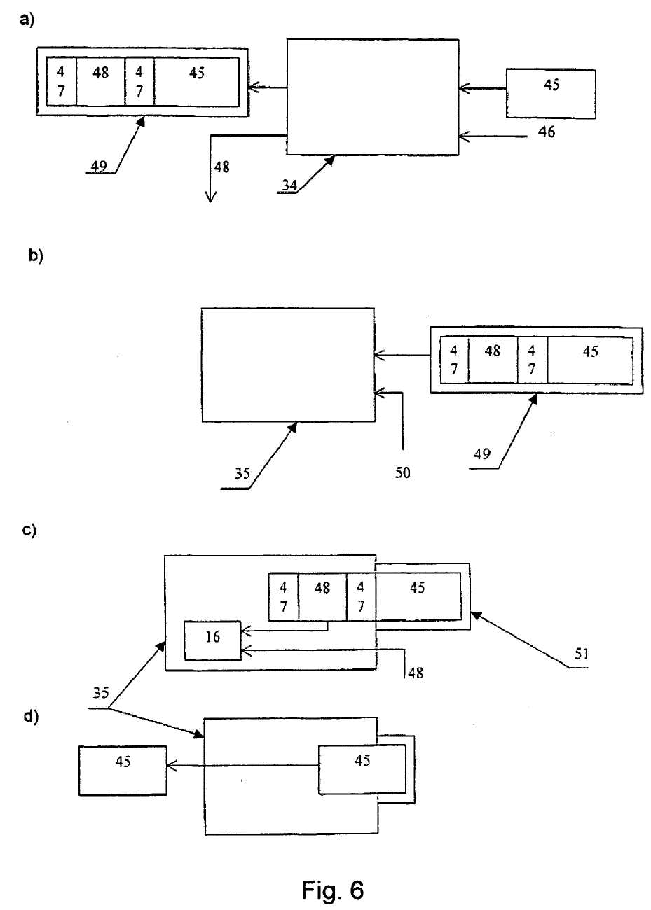

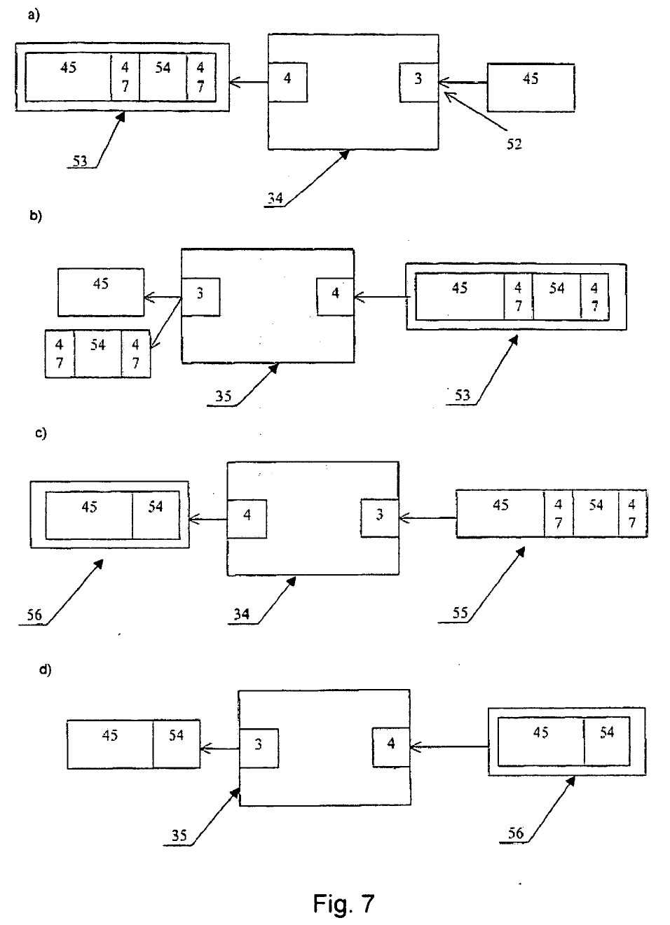

In a case when the encryption of information is carried out in an electronic letter mode to send the encrypted information further to a user-addressee, a sender inputs an individual number 19 of personal cryptoprotective complex of the addressee (FIG. 5) to the cassette 1 by means of the terminal device 2, and also inputs a command to encrypt a message 40. The encryption and decryption of the message includes the following steps:

in the personal cryptoprotective complex 34 (FIG. 5) being a sender of information 40, producing a random number Z 36 and storing said random number in a random access memory 18, inputting an individual number I-19 of the personal cryptoprotective complex 35 of an information recipient, generating a single-use encryption key by reading the stored random number Z and the individual number I out of a random access memory, executing an arithmetic operation on the random number Z and the individual number I to derive a resulting number X 38, and storing the resulting number X in the random access memory 18, generating a dynamically transformable daughter code 39 on the basis of the mother code 15 and the single-use encryption key 38, inputting and dividing the sent information 40 into packets of a determined size, encrypting the packets with use of the dynamically transformable daughter code, and outputting the encrypted packets of information 43 to record onto a medium together with the random number Z 36 to transmit it further to the recipient, wherein the transformation of said dynamic daughter code is made according to the moment of terminating the encryption of a predetermined amount of information bytes;

in the personal cryptoprotective complex 35 being the recipient of information, reading an individual number I-19 of the personal cryptoprotective complex of the information addressee out of the ROM 17 and storing said individual number in the random access memory 18, inputting the number Z 36 received from the information sender to the random access memory, generating a single-use encryption key by reading the stored random access number Z and the individual number I out of the random access memory, executing an arithmetic operation on the random number Z and the individual number I to derive the resulting random number X 38, and storing the resulting random number X in the random access memory, generating the dynamically transformable daughter code 39 on the basis of the mother code 15 and the single-use encryption key 38, inputting the encrypted packets of information 43 from the medium, and decrypting the packets by means of said dynamic daughter code 39, wherein the transformation of said dynamic daughter code is made according to the moment of terminating the decryption of a predetermined amount of information bytes, and combining the packets and outputting the decrypted information 44 to the information recipient.

Both methods of information encryption/decryption using the personal cryptoprotective complexes prevent decryption of the intercepted information by an eavesdropping user 81 (FIG. 13). The basic obstacle for decrypting information by the user 81 who uses the devices similar to that of the users 34 and 35, is that the information processing program 22 recorded in the ROM 17 of each cassette monitors all commands of a user, and when commands of the user are incorrect from the viewpoint of the program, such commands are ignored. Thus, the cassette of the user 81 will be unable to generate a single-use key of the communication session 38 from the intercepted numbers 36, 37 in the diagram a) (FIG. 13) and 36, 19 in the diagram c) (FIG. 13) since the following conditions are not met: in the diagram (a), one of the random numbers 36 or 37 should be necessarily derived by own random-number generator, and in the diagram (c), the number 19 should be own individual number of the cassette. In a case with the variant (b) of the diagram (FIG. 13), a single-use protected-communication-session-establishment-acknowledgement password is generated simultaneously with generation of a daughter key of the communication session in each of personal cryptoprotective complexes 34 and 35, said password coinciding at the present participants of the communication session only at absence of active listening, and being used to make sure of establishment of the protected communication session.

In encryption of electronic documents, the need is frequently generated that other users of personal cryptoprotective complexes might familiarize in future with the text of an electronic document. For this purpose there is an encryption mode with application of a decryption password of a given electronic document 45 (FIG. 6). When this mode is switched on by a user's command 46 to establish the password, a random number Y 48 is generated in the cassette 1 prior to begin the encryption, said random number being further a decryption password of the electronic document. The information processing program inserts the number Y in the beginning of the electronic document to be encrypted, wherein the present number is marked with service symbols 47 at both sides, said symbols together with the number Y 48 forming service information. The number Y is outputted to the user who transmits said number to other users together with the encrypted electronic document.

The decryption of the electronic document is as follows. The user 35 inputs a command 50 to decrypt the electronic document to the cassette, and inputs the decryption password—the number Y, then inputs an initial part of the encrypted electronic document containing the encrypted number Y. Inputted data is the basis to generate a single-use key X in the cassette, used to generate a dynamically transformable daughter code using which a part of the electronic document that contains the number Y is decrypted. Then the comparison of the number Y inputted by the user and the decrypted number Y is made. If the numbers coincide, the cassette continues decryption of the electronic document and outputs the decrypted text of the electronic document to the user. The comparison of the numbers Y may occur in another way as well, that is to say: the inputted number Y is encrypted, its cryptogram is collated with the encrypted number Y, and in case of coincidence, the cassette starts decryption of the electronic document. For convenience of a user who encrypts the electronic document with application of the decryption password, the user can use as a password his or her own set of symbols D inputted to the cassette together with a command to establish the decryption password. Then, using the random-number generator in the cassette, the random number Y is produced and a determined reversible arithmetic operation between said random number Y and the number D is executed, and the final result is a number F being outputted to the user together with the encrypted electronic document for transmission to the personal cryptoprotective complexes of other users or for record on media. At least in one anyone personal cryptoprotective complex, the number F is inputted, the decryption password D is inputted, the arithmetic operation is executed between said numbers, the obtained result Y is stored in the random access memory of the personal cryptoprotective complex and is used for decrypting the inputted information. Besides, service information of the encrypted electronic document may contain the commands included by command of the user of the personal cryptoprotective complex 34, said commands being addressed to personal cryptoprotective complexes and establishing the date and time of decrypting the electronic document, so a personal cryptoprotective complex of any user decrypting the electronic document will decrypt it only after the expiration of said date and time, and predetermined commands permissive of making a certain modification in the contents of the electronic document may be included as well.

The encryption/decryption program should provide counteraction to calculation of the mother code by comparison of an unlimited array of initial information and the same array of a cryptogram of given information. For this purpose, the program includes operations having irreversible character. The encryption and decryption proceeds as follows:

1) reading the number X 38 out of the random access memory 18, reading a first number M1 of the mother code 15 out of the memory 14, executing an arithmetic operation on the numbers X and M1 to derive a first resulting number of a determined digit capacity, said resulting number being stored in the random access memory 18, wherein k low-order digits are separated from said number, and a number corresponding to a determined number of the digit capacity k is assigned to the obtained number P1;

2) reading said first number P1 out of the random access memory 18, reading a second number M2 of the mother code 15 out of the memory, executing the arithmetic operation on the numbers P1 and M2 to derive a second number P2, and storing said number P2 in the random access memory 18;

3) repeating step (2) for numbers P(i−1) and Mi, where i=3, . . . , N, for derivation of a set of numbers P3, . . . , PN stored in the random access memory 18;

4) forming two subsets of the set of numbers P1, . . . , PN, a first of which consists of numbers corresponding to k low-order digits of numbers P1, . . . , PN, and a second set consists of the numbers corresponding to m high-order digits of numbers P1, . . . , PN, grouping the second subset of numbers into a table to addresses corresponding to numbers of the first subset, the quantity of said numbers being equal to a possible quantity of numbers in the first subset;

5) selecting a column of the table with a maximum quantity of numbers from the second subset or all columns with an identical maximum quantity of numbers, and executing sequentially the arithmetic operation with consecutive pairs of numbers of selected columns, as a result of which an intermediate number K is obtained;

6) repeating the processing steps (1)-(4) for the number K and the set of numbers P1, . . . , PN, wherein step (4) includes selecting k=8 bits and distributing the obtained numbers of the second subset into the table with 256 columns numbered by one of 256 bytes, wherein columns with the quantity of numbers less than two are added by numbers from columns with the maximum quantity of numbers;

7) sequentially executing the arithmetic operation with consecutive pairs of numbers from columns to obtain a number Q1, . . . , Q256 of a determined digit capacity for each column,

8) forming two subsets of the set of numbers Q1, . . . , Q256, a first of which consists of numbers corresponding to 4 low-order digits of numbers Q1, . . . , Q256, and a second set consists of the numbers corresponding to remaining high-order digits of numbers Q1, . . . , Q256, grouping the second subset of numbers into a 100×100 table to addresses corresponding to numbers of the first subset;

9) forming a 16×16 table of bytes corresponding to the second subset of numbers from step (8) by consecutive row-wise passing through the 100×100 table, finding cells therein with numbers of said second subset, and recording bytes corresponding to the found numbers into the 16×16 table in the same sequence;

10) executing arithmetic operations on numbers of the second subset from the step (8) corresponding to at least two next bytes for every byte of the 16×16 table to obtain two new subsets and a second 16×16 table, by repeating steps (8)-(9);

wherein steps (1)-(10) are carried out identically in both encryption and decryption, further encryption of information is carried out by representing information in 8-bit bytes, substituting them into the first table, comparing coordinate bytes of initial information in the first table with similar coordinate bytes in the second table, replacing the bytes of initial information by bytes from the second table with said coordinates, and outputting cryptogram bytes obtained as a result of replacement for the subsequent transmission, and decrypting information by replacing the obtained cryptogram bytes by their substitution into the second table, comparing coordinates of the cryptogram bytes in the second table with similar coordinates of bytes in the first table, and replacing cryptogram bytes by bytes from the first table with said coordinates, and outputting bytes obtained as a result of replacement to the user;

11) after the encryption and decryption of a determined amount of information by means of the generated daughter code, updating the first and second 16×16 tables by removal of the first table, its replacement by the second table, and generation of the new second table according to step (10).

Arithmetic operations on numbers should be executed by dividing one number by another one and storing of the obtained result in the random access memory 18, followed by selecting n meaning figures in the obtained number which are represented as a natural integer of a digit capacity n, and storing this number instead of a result of division in the memory for further use.

To accelerate the encryption and decryption processes, the following way is used in each personal cryptoprotective complex: prior to begin the encryption and decryption of information, creating several 16×16 tables in the total amount R by repeating steps (8)-(9), said amount being predetermined and more than two, and storing said tables in the random access memory 18, wherein an information packet consists of a determined amount of bytes and is encrypted and decrypted using two 16×16 tables, starting with the first and second tables, then encrypting and decrypting a next information packet using the first and third tables and so on up to the last 16×16 table that is also used in a pair with the first table, then deleting the first table, replacing it with the second table, replacing the second table with the third table and so on up to the last table put on a place of the penultimate table, and putting a new 1 6×16 table on a place of the last table, said new table being formed according to the step (10), and continuing the encryption and decryption of information packets, starting with the first and second tables.

To enhance the cryptoresistance, it is possible to replace the 8-bit representation of information by the 9-bit representation. In this case, the processing steps (1)-(4) are repeated, wherein step (4) comprises selecting k=9 bits, and the obtained numbers of the second subset are distributed into a table with 512 columns numbered by one of 512 bytes, while the columns with a quantity of numbers less than two are added by numbers from columns with a maximum quantity of numbers, the 16×16 table is replaced by a 8×8×8 table, and the 100×100 table is replaced by a 100×100×100 table.

When encrypting and decrypting the electronic documents, a table-transformation relationship of the encrypted/decrypted information is introduced at the step (11), which gives protection against modification in the encrypted text of the electronic document, because one modified symbol of the cryptogram will result in propagation of modification over all subsequent text in decryption of the electronic document.

To provide additional protection against modification in the encrypted information, the hashing of each packet of initial information is applied wherein a hashing result is added to the packet, the obtained packet is encrypted by a second hash-function with addition of a second hashing result. The authenticity of the encrypted information is established by the following steps: receiving the transmitted encrypted packets and the second hashing result added to each packet, restoring data partially lost or deformed in data transmission with use of the second hashing result by inverse hashing to obtain at least one variant of the encrypted information packet, decrypting at least one variant of the encrypted information packet, and recording at least one variant of a decrypted packet in the random access memory. The reverse hashing of decrypted information packets takes place using the first hashing result, and the search for an authentic variant of an initial information packet is carried out, wherein said authentic variant is outputted to the user only upon its detection, and all other false variants of a decrypted packet are deleted from the random access memory.

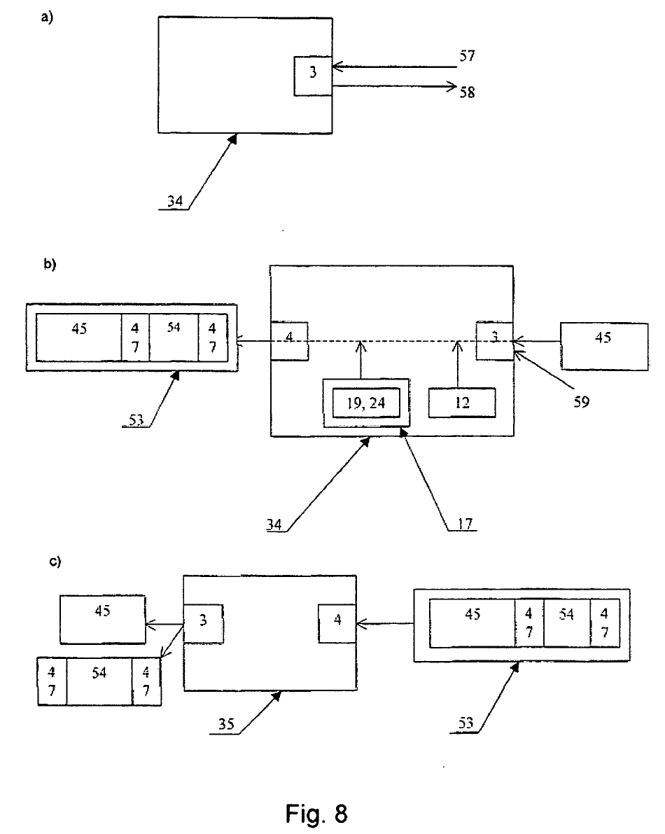

The problem of authenticating electronic documents 45 (FIG. 8) is solved as follows:

A command 57 to sign an electronic document 45 is inputted to the cassette 1 of the personal cryptoprotective complex by means of the terminal device 2. The cassette outputs a user identification request 58 to a user, and the user inputs his or her identification data 59. At the coincidence of the inputted identification data with the stored data, the cassette starts the encryption of the electronic document 45 in a protection-against-modification mode. The text of the electronic document is inputted through the terminal device 2 from an input device or a medium. After termination of the text encryption, a first service symbol 47, service information 54, and a second service symbol 47 closing the service information are added under control of the information-processing program to the text of the electronic document. At the same time, the encryption of the text of the electronic document, service information and service symbols is made as an encryption of the unified document by one single-use key X 38. Service information 54 in this case consists of user's data 24 representing an electronic digital signature, an individual number 19 of the personal cryptoprotective complex, signing date and time taken from the built-in clock 12. When outside users 35 decrypt the electronic document, firstly, the text of the electronic document is decrypted and outputted to the user through the terminal device 2, and then the service information 54 determined by the information processing program 22 using the service symbols 47 is decrypted and outputted for the user onto a display with indication that the present information really is an electronic digital signature exactly of the present electronic document. The electronic digital signature is used to establish the signing date and time and the person who has signed the electronic document, because a registering clerk preliminary puts the user's data present in the electronic digital signature to the ROM 17 of the personal cryptoprotective complex simultaneously with its recording in a public database 85 (FIG. 13). Besides, the electronic digital signature includes an electronic photo of the user that allows identification of the electronic digital signature without reference to the database.

The electronic digital signature of a user of a personal cryptoprotective complex is registered by following steps:

taking user's data 24, an individual number 19 of a cassette 1 of his or her personal cryptoprotective complex 34, a user statement recorded by a digital video camera and containing information that allows to identify the user;

inputting information to a personal cryptoprotective complex of a registering clerk, signing the received information with an electronic digital signature of the registering clerk, encrypting said information and sending it to a central server;

inputting information to a central cryptoprotective complex, decrypting the received information, putting the decrypted information into the database 85 of electronic digital signatures, generating the electronic digital signature of the user from the received information, certifying said signature by an electronic digital signature of the central cryptoprotective complex containing a predetermined information, encrypting and sending said information to the personal cryptoprotective complex 34 of the user;

receiving and decrypting information in accordance with an incorporated program, checking the electronic digital signature of the user for conformity with a typical template, checking presence of the electronic digital signature of the central cryptoprotective complex, collating an individual number contained in the received electronic digital signature of the user with the individual number of the personal cryptoprotective complex of the user, and in case of positive results, recording the electronic digital signature of the user to the ROM 17 of the cassette of his or her personal cryptoprotective complex.

In contrast to the electronic digital signature stored in the ROM 17 of the cassette 1 of the user, an electronic seal contains data of a determined legal person and is stored in the PROM 13 of the cassette 1. In contrast to the electronic digital signature, the electronic seal can be transmitted from one cassette to another with simultaneous removal from the PROM 13 of the cassette from which the transmission is made. The electronic seal is registered similarly to registration of the electronic signature.

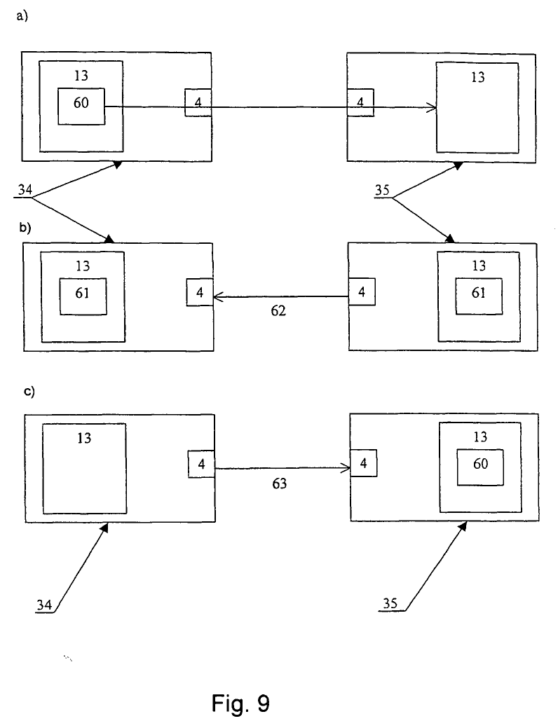

The personal cryptoprotective complex makes any electronic document certifiable using the right of ownership by any user being in possession of the present electronic document, said certification being without modification in the contents of the electronic document. An embodiment of such electronic document is an electronic bearer bill. The present electronic document has a property of protection against copying by analogy to documents on the paper medium that are protected against copying in various ways (holographic marks and watermarks, a background pattern, and sewn-in threads). Specificity of protection of the electronic document against copying is that not a plaintext of the electronic document but its cryptogram or a decryption password of the electronic document cryptogram is protected against copying. Accordingly, the proof of being in possession of a copy-protected electronic document is the ability of the user of personal cryptoprotective complex to receive the decrypted text of the present electronic document using the cassette in which the cryptogram or the decryption password of the electronic document cryptogram is stored. The plaintext of the copy-protected electronic document is considered to be a copy of said document. The personal cryptoprotective complex allows provision of any electronic document with the property of protection against copying. For this purpose, the input of user's information to the personal cryptoprotective complex 34 (FIG. 9) includes the input of user's commands to set a user's information-processing mode and to generate a non-copied electronic document, and the processing of the inputted user's information.

Then, in accordance with the established mode of processing the user's information and the earlier received information, service information 54 is generated by means of the information processing program 22 and is combined with the processed user's information to obtain an electronic document 60, attributes of the electronic document in the form of service information 54 are separated from the processed user's information with the predetermined service symbols 47, and in accordance with the user's command to generate the non-copied electronic document, a certain command in the form of a typical set of symbols earlier inputted to the ROM 17 is included in the service information as a part of the information processing program 22 for the personal cryptoprotective complexes, and the obtained electronic document 60 is stored in a section of the PROM 13 provided in the personal cryptoprotective complex and intended for non-copied electronic documents.

The transmission of the electronic document with protection against copying by protection of the electronic document cryptogram against copying is carried out by the following method that comprises:

establishing a protected communication session with application of personal cryptoprotective complexes 34 and 35 on the basis of a single-use key 38 of the communication session generated using random numbers, and inputting a user's command to transmit a non-copied electronic document 60 recorded in a PROM 13 to other subscriber of the established communication session;

encrypting the electronic document by a dynamically transformable daughter code 39 while reading an electronic document inability-for-copying command out of service information 54, establishing the protection against modification to the encrypted information, and transmitting the encrypted information to another personal cryptoprotective complex 35;

upon termination of transmission of the non-copied electronic document 61, disabling it for a predetermined time period T1 in the PROM 13 according to said inability-for-copying command;

receiving the electronic document and decrypting the electronic document, establishing the reliability of information by check for absence of distortions in said information,

searching for and selecting service information from decrypted information by means of service symbols 47, using the service symbols to find the service information 54 containing the electronic document inability-for-copying command, recording the electronic document to the section of the PROM 13 intended for non-copied electronic documents, and disabling said document 61 for the predetermined time period T1;

generating an electronic-document-loading-acknowledgement password 62 in the personal cryptoprotective complex 35 of a receiving party and transmitting the electronic-document-loading-acknowledgement password in the encrypted form to the personal cryptoprotective complex 34 of a sending party;

in case if the sender does not receive the electronic-document-loading-acknowledgement password 62 from the recipient during the time period T1, enabling the electronic document in the PROM of the personal cryptoprotective complex 34 of the sender, while ignoring the subsequent reception of said password;

in case if the recipient does not send the electronic-document-loading-acknowledgement password 62 to the sender during the time period T1, deleting the electronic document from the PROM 13 of the personal cryptoprotective complex 35;

receiving the electronic-document-loading-acknowledgement password 62 in the personal cryptoprotective complex 34 of the sending party, generating an electronic-document-transmission-acknowledgement password 63, and requesting a user acknowledgement in response to the sending of the present password to the personal cryptoprotective complex 35 of the receiving party;

in case if the user gives no acknowledge in response to the sending of the password 63 during a predetermined time period T2, then, on the expiration of said time period, automatically enabling said electronic document in the PROM 13 of the personal cryptoprotective complex 34 of the sender, and automatically deleting said electronic document in the PROM 13 of the personal cryptoprotective complex 35 of the recipient;

in case if the user acknowledges the sending of the password 63 during the time period T2, sending the present password in the encrypted form to the personal cryptoprotective complex 35 of the recipient, wherein said electronic document 61 is automatically deleted from the PROM 13 of the personal cryptoprotective complex 34 of the sender, and said electronic document is automatically enabled in the PROM 13 of the personal cryptoprotective complex 35 of the recipient when he or she has received said acknowledgement password 63 for transmission of the electronic document 60, followed by inputting user's commands, establishing a mode of processing the decrypted information according to the user's commands received from the service information and according to the earlier inputted information and the information processing program 22, and outputting the processed information 60 to the user together with service symbols 47 that authenticate attributes of the received electronic document.

In a case if a copy-protected electronic document 60, in particular an electronic bill, contains a variable face value denoted in a predetermined way by means of service symbols 47, then, after the decryption of the present electronic document there are the steps of: determining a variable face value information of the electronic document in the service information 54, and outputting said variable face value information to the user; subdividing the electronic document 60 into arbitrary parts by changing face values of parts using the information processing program 22 in such a manner that their total sum remains invariable, wherein other characteristics and attributes of parts of the electronic document also remain unchangeable; sending parts of the electronic document to other personal cryptoprotective complexes; receiving several identical electronic documents 60 with variable face values to the personal cryptoprotective complex and automatically collecting said documents using the information processing program 22 into a unified electronic document by summing their face values.

If the electronic document 60 with a variable face value is an electronic bank bill of exchange with a predetermined time for repayment, and the service information 54 of said bill contains data of a bank drawn the bill, including electronic digital signatures of the bank generated using a personal cryptoprotective complex, data of a user who has received the bill, currency and a face value of the bill as well as a bill repayment date, then, after said date the bank will enable (defreeze) a mortgage amount of money left at a user's account that will be transferred ahead of time to any holder of the present electronic bill or its part after reception of the electronic bill to the personal cryptoprotective complex of the bank, identify data of the electronic bill and determine its face value, and if the date of repayment indicated in the bill is not later than a current date, the holder will obtain the sum corresponding to the face value of the presented electronic bill.

If an electronic document 60 with a variable face value is electronic cash, settlements in electronic cash are made as follows: connecting personal cryptoprotective complexes 34 and 35 to each other directly or with use of a communication channel; establishing a protected communication session with application of the personal cryptoprotective complexes on the basis of a dynamically transformable daughter code 39 generated using single-use keys 38 obtained with use of random numbers 36 and 37, and inputting a user's command to transfer electronic cash of a certain currency and sum recorded in a PROM 13 to other subscriber of the established communication session; checking presence of a record in the PROM 13 of the personal cryptoprotective complex 34, said record corresponding in the form and contents to electronic cash of required currency; if said record present in the PROM 13, reading out the sum corresponding to electronic cash and collating it with a requested sum; in case if the requested sum does not exceed the read out sum, outputting a user identification request to the user; inputting information to the personal cryptoprotective complex and collating it with data 24 stored in the personal cryptoprotective complex and appropriately identifying the user; in case of coincidence, generating a typical electronic document by means of the information processing program 22 inputted earlier, said typical electronic document containing a record of electronic cash in the currency and amount requested by the user; simultaneously modifying the record of the electronic cash stored in the PROM 13 while reducing its cost by the transferable sum; and encrypting said electronic document by the dynamically transferable daughter code 39, establishing protection against modification in the encrypted information and transmitting the encrypted information to the personal cryptoprotective complex of the user with which the protected communication session is established; on the termination of successful transmission of the electronic document, deleting it from the PROM 13; receiving the electronic document, decrypting the electronic document, establishing the reliability of information by check for absence of distortions in information, and making a record in the PROM 13, said record corresponding in the form and contents to the received electronic cash.

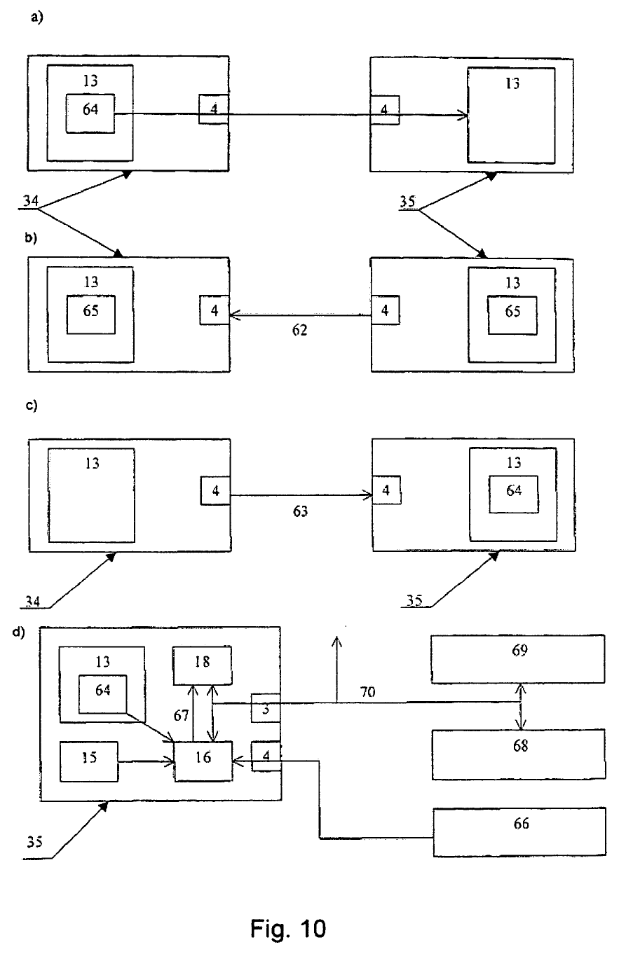

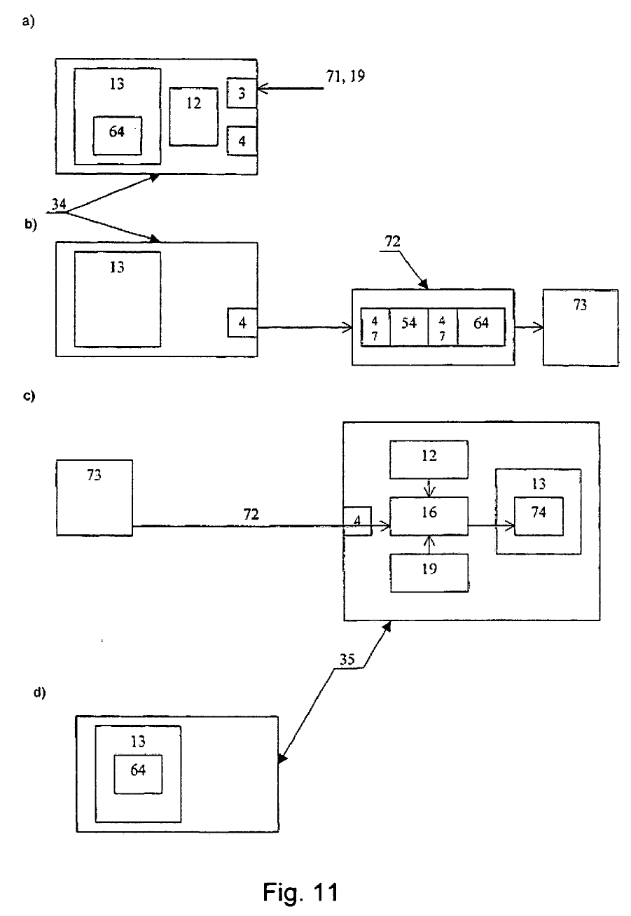

In case if a cryptogram decryption password 64 (FIG. 10) is used for protection against copying, there are the steps of: generating a decryption password on the basis of a random number and recording it to a section of a PROM 13 intended for non-copied decryption passwords and closed for users, generating a dynamically transformable daughter code 39 on the basis of the mother code 15 and the decryption password 64; inputting information, including a computer program, to the personal cryptoprotective complex, and making its encryption using said decryption password, outputting the encrypted information 66 to a user for record to a medium or for transmission to other user, inputting a command to transmit the decryption password 64 to other user in process of the protected communication session, encrypting the decryption password on the basis of a single-use key 38 generated using at least one random number, and outputting said password for transmission. The transmission of the decryption password 64 is carried out similarly to transmission of copy-protected electronic documents.

In this case, it is possible to protect against copying not only electronic documents, but also computer programs and databases. If that is the case, a decrypted fragment 67 of the computer program 66 is recorded to the RAM 18 of the cassette. The processing of decrypted fragments of the program takes place in parallel in two processors: the microprocessor 16 of the cassette and a microprocessor 68 of a computer; the processing involves a partial use of a RAM 69 of the computer. Since the part of operations of processed fragments 70 is made within the cassette 1, it is practically impossible to restore decrypted fragments of the encrypted program 66 completely.

If it is necessary to limit a validity period of the decryption password in time or quantity of events of use, the following steps are carried out: including appropriate service commands in the decryption password and selecting them by means of service symbols 47; encrypting the received service commands in structure of the decryption password 64, and outputting them for the further record to a medium or transmission to other user while storing the decryption password in the PROM 13, simultaneously disabling the access to the decryption password 64 residuary in the PROM 13 of the personal cryptoprotective complex of the user for a predetermined time interval; inputting or accordingly receiving the encrypted decryption password 64 with service commands included therein; selecting service commands by means of service symbols 47, and executing operations with the present decryption password 64 according to the received commands from the service information 54, exactly: deleting the decryption password 64 from the memory of the personal cryptoprotective complex after the expiration of time pointed in the service information or after use of the decryption password as much times as indicated in the service information.

To transmit the decryption password 64 from one personal cryptoprotective complex to another, it is possible to use an independent medium 73 (FIG. 11). In this case, there are the steps of: adding service information 54 selected by means of service symbols 47 to the decryption password 64, with the indication of the individual number 19 of the personal cryptoprotective complex of the recipient, and also of date and time after which expiration the recipient of the present decryption password can transmit said password to other users of personal cryptoprotective complexes. Simultaneously, an electronic letter is generated in the personal cryptoprotective complex 34 of the sender of the decryption password, said letter including the decryption password 64 with the service information 54 added thereto, and the date and time in the form of service information are additionally indicated as well, and the personal cryptoprotective complex of the electronic letter recipient will be able to decrypt said message only before the expiration of said date and time, wherein the date and time of decrypting the electronic letter should be indicated earlier than or identical to the date and time indicated in the service information of the decryption password. The generated electronic letter is encrypted with the dynamically transferable code based on the single-use key generated from a random number and an individual number of the personal cryptoprotective complex of the recipient of the present electronic letter, and said random number is added to the encrypted electronic letter. The encrypted electronic letter 72 and the random number are outputted for transmission to the addressee together with information encrypted by means of the decryption; the encrypted electronic letter 72 containing the decryption password 64 is recorded together with the random number to the medium 73 or is transmitted through a communication link, and after termination of transmission, the decryption password is deleted from the PROM 13 of the personal cryptoprotective complex 34 of the sender. Then, there are the steps of: receiving the encrypted electronic letter 72, the random number and the encrypted information 66; inputting the random number to the RAM 18 of the personal cryptoprotective complex 35, and reading the individual number 19 of the personal cryptoprotective complex out of the ROM 17 and recording it to the RAM 18 as well; generating a single-use key on the basis of the inputted random number and the read-out individual number, generating the dynamically transformable code on the basis of the single-use key and inputting the encrypted electronic letter 72 to the personal cryptoprotective complex 35, decrypting the electronic letter using the dynamically transformable code and recording the decrypted text of the electronic letter 72 to the RAM 18, defining service information 54 using service symbols 47, finding the service information with indication of the final date and time of decrypting the electronic letter and collating them with the date and time in the built-in clock 12, and in case if the final date and time are later than the current date and time, deleting the present electronic letter from the RAM 18, finding the decryption password 64 which includes the date and time after which expiration the decryption password may be transmitted to other users, and recording said decryption password to the section of the PROM 13 of the personal cryptoprotective complex 35, intended for non-copied decryption passwords and closed for users of the PROM. Information, including a computer program, is inputted to the personal cryptoprotective complex and is decrypted on the basis of the dynamically transformable code generated using the decryption password read out of the PROM; after the expiration of date and time pointed in the service information included in the decryption password, the present service information is deleted from the PROM 13, with simultaneous removal of the restriction on the further transmission of the decryption password 64 to other users.

Electronic documents with protection against copying (including decryption passwords 64) may be transmitted by other methods developed by varying the time period T1 and T2 and by adding the additional data in the form of numbers N1 and N2.

Thus, a temporary individual number N2 generated by the random-number generator 20 is added to the electronic document into the service information, and an arbitrary time value T2 is inputted as well, said number and value being encrypted together with the electronic document.

A command is inputted to transmit the electronic document to other user during the protected communication session or in the encrypted electronic letter; when the transmission of the present electronic document terminates, said document is disabled for a predetermined time period T1 in the PROM 13 of the sender and is marked with an assigned temporary individual number; in case of failures in transmission of the electronic document, the sender repeatedly sends the present electronic document with the same accompanying data; the electronic document is received, and there are the steps of decrypting the electronic document, establishing the reliability of information by check for absence of distortions in the information; searching for and selecting service information 54 from the decrypted information by means of service symbols 47, using service symbols to find service information containing an electronic document inability-for-copying command and the temporary individual number of the present document; collating said number for presence of a disabled electronic document having the same number in the PROM, and in case if coincidence is absent, recording the electronic document to the section of the PROM 13 intended for non-copied electronic documents, marking it with the assigned temporary individual number and disabling the electronic document for the predetermined time period T1. An electronic-document-loading-acknowledgement password 62 is generated on the basis of a random number in the personal cryptoprotective complex 35 of the receiving party, said temporary individual number N2 of the present electronic document is automatically added to said password, a password copy is recorded to the PROM 13, and the electronic-document-loading-acknowledgement password 62 is transmitted in the encrypted form to the personal cryptoprotective complex 34 of the sending party during the protected communication session or in the encrypted electronic letter; the electronic-document-loading-acknowledgement password 62 is received in the personal cryptoprotective complex 34 of the sending party, finding the disabled electronic document in the PROM 13, said document being marked by number corresponding to a number received with the password, and in case of presence of the disabled electronic document and coincidence of numbers there is the step of generating an electronic-document-transmission-acknowledgement password 63 with use of electronic-document-loading-acknowledgement password, said temporary individual number N2 of the electronic document being automatically included therein; requesting a user acknowledgement for sending said password to the personal cryptoprotective complex of the receiving party. In case if the user does not give acknowledgement for sending the password 63 during an arbitrary time period T2 which value was inputted beforehand by the sender in establishment of an electronic document sending mode, then after the expiration of a predetermined period of time there are the steps of: automatically enabling said electronic document in the PROM 13 of the personal cryptoprotective complex 34 of the sender; and automatically deleting said electronic document in the PROM 13 of the personal cryptoprotective complex 35 of the recipient. In case if the user gives acknowledgement for sending the password 63 during the time period T2, then said password in the encrypted form is sent to the personal cryptoprotective complex 35 of the recipient, wherein said electronic document is automatically deleted from the PROM 13 of the personal cryptoprotective complex 34 of the sender, and when the recipient has received the electronic-document-transmission-acknowledgement password, there is the step of finding the disabled electronic document and the recorded copy of the electronic-document-loading-acknowledgement password 62 in the PROM 13 of the personal cryptoprotective complex 35 of the recipient, said document and said copy being denoted by number N2 corresponding the number received with the password, and only in case of presence of the disabled electronic document, coincidence of numbers and presence of a direct association between passwords, said electronic document is automatically enabled; then the electronic document is recorded to the section of the PROM 13 of the personal cryptoprotective complex 35, intended for non-copied electronic documents and closed for users of the PROM, and said temporary individual number N2 is deleted. In case of failures in transmission of the electronic document or acknowledgement passwords, users carry out the backup of transmission.

A number N1 corresponding to an individual number 19 of the personal cryptoprotective complexes of the third party is used in a case when the electronic-document-transmission-acknowledgement password is assumed to be sent from another personal cryptoprotective complex. In this case, an individual number N1-19 of the personal cryptoprotective complex where from the electronic-document-transmission-acknowledgement password will be sent, a temporary individual number N2 generated by the random-number generator 20, and an infinite value T2 of the time period to be inputted by the user, said number and value being encrypted together with the electronic document, are added to the transmittable electronic document; a command is inputted to transmit the electronic document to other user in process of the protected communication session; when the transmission of the present electronic document terminates, said document is enabled for a predetermined time period T1 in the PROM 13 of the sender and is marked with said assigned number N2. There are the steps of: receiving the electronic document and decrypting the electronic document, establishing the reliability of information by check for absence of distortion in information; searching for and selecting service information 54 from the decrypted information by means of service symbols 47, using said service symbols to find service information containing an electronic document inability-for-copying command and numbers of said document, recording the electronic document to the section of the PROM 13 intended for non-copied electronic documents, marking said document with its assigned number N2 and disabling the electronic document for the predetermined time period T1, generating the electronic-document-loading-acknowledgement 62 in the personal cryptoprotective complex 35 of the receiving party, automatically adding said number N2 of the present electronic document to said password and transmitting the result in the encrypted form to the personal cryptoprotective complex 34 of the sending party during the same or other protected communication session; receiving the electronic-document-loading-acknowledgement 62 of the electronic document in the personal cryptoprotective complex 34 of the sending party, finding the disabled electronic document in the PROM 13, said document being marked by number N2 corresponding to the number received with the password, and in case of presence of the disabled electronic document and coincidence of numbers, deleting the present electronic document from the PROM 13, because the time period T2 is equal to an infinite value; in the personal cryptoprotective complex whose individual number 19 corresponds to the number N1 assigned to the electronic document, inputting a numerical value corresponding to the number N2 of the electronic document, generating the electronic-document-transmission-acknowledgement password 63 while automatically including therein own individual number 19 corresponding to N1 and the inputted number N2. The present password 63 in the encrypted form is sent to the personal cryptoprotective complex 35 of the recipient of the electronic document; when the personal cryptoprotective complex 35 of the recipient has received the electronic-document-transmission-acknowledgement password in its PROM 13, there are the steps of: finding the disabled electronic document marked by the number N2 corresponding to the number received with the password, collating the numbers N1 in the electronic document and in the password, and only if coincidence of numbers takes place, automatically enabling said electronic document, and then recording the electronic document to the section of the PROM 13 of the personal cryptoprotective complex 35, intended for non-copied electronic documents, and deleting the added numbers N1 and N2.

The following method for transmitting copy-protected electronic documents is characterized in that the user inputs an arbitrary time T1, an infinite value of the time period T2, and adds the temporary individual number N2 generated by the random-number generator 20. An electronic-document-loading-acknowledgement password 62 is absent in the present method. And the electronic-document-transmission-acknowledgement password 63 works as an independent electronic document which can be freely transmitted from one user to another in a protection-against-copying mode with obligatory automatic removal from the cassette of the personal cryptoprotective complex said password is transmitted from.

To generate the electronic-document-transmission-acknowledgement password 63, the following steps are carried out: inputting a command to generate an electronic-document-acknowledgement password; generating the electronic-document-acknowledgement password; assigning a number and a variable face value, if any, thereto, said number and variable face value corresponding to the temporary number and temporary face value of the electronic document; transmitting the electronic-document-transmission-acknowledgement password in the encrypted form during a cryptoprotective communication session to a certain user or keeping said password in own personal cryptoprotective complex 34.

In the present method, the electronic document is disabled during the time period T1 in the PROM 13 of the personal cryptoprotective complex of the sender, but thus the electronic document may be unlimitedly copied and distributed to other users in process of cryptoprotective communication sessions or in electronic letters with the appropriate mark that the electronic document received by others users is a copy. After the expiration of the time period T1, there are the steps of: deleting the electronic document from the PROM 13 of the sender 34; receiving copies of the electronic document, decrypting the electronic document, searching for and selecting service information 54 from the decrypted information by means of service symbols 47; finding a mark that there is a copy of the electronic document, and a temporary individual number N2 of the present document; recording the electronic document to the section of the PROM 13 and marking it with the assigned temporary individual number N2. The electronic-document-transmission-acknowledgement password is received in a personal cryptoprotective complex of a user who has received the electronic document copy, said electronic document copy marked with the number N2 corresponding to the number N2 received with the password 63 is found in the PROM 13; and if the numbers coincide, the mark that there is a copy is removed from the electronic document copy, and then the electronic document is recorded to the section of the PROM 13 of the personal cryptoprotective complex, intended for non-copied electronic documents and closed for users of the PROM, and said temporary individual number N2 is deleted. After the transmission of said password, it is deleted from the PROM 13 in the personal cryptoprotective complex of the sender of the electronic-document-transmission-acknowledgement password, and if a part of the password is transmitted with a variable face value, a face value of a part of said password residuary in the PROM 13 is decreased by the sum equal to the transmitted part.

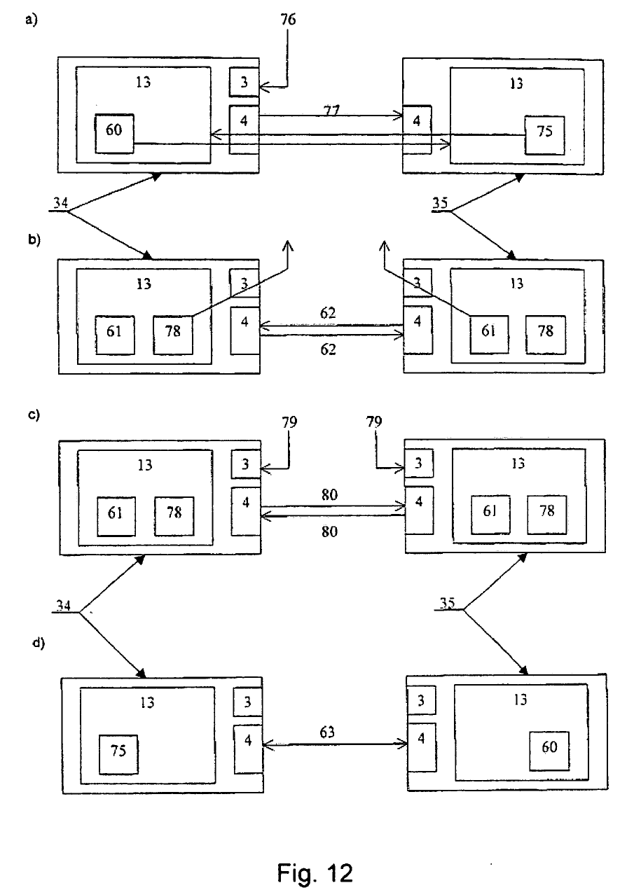

The personal cryptoprotective complex allows a procedure of a simultaneous exchange of the copy-protected electronic documents through a communication link with preview of electronic documents. There are the following steps for this purpose: synchronously generating a single-use encryption key 38 (FIG. 12) on the basis of random numbers 36 and 37 produced in the personal cryptoprotective complexes 34 and 35 of users; synchronously generating the dynamically transformable daughter codes 39 on the basis of a mother code 15 and the single-use encryption key 38 in the personal cryptoprotective complexes of users; inputting initial information to each of the personal cryptoprotective complexes of users; in accordance with the established mode of processing the user's information and the earlier received information, generating service information 54 by means of the information processing program and combining the service information with the processed user's information to obtain an electronic document 60, wherein attributes of the electronic document in the form of service information 54 are separated from the processed user's information by means of predetermined service symbols 47; and in accordance with a user's command to generate the copy-protected electronic document, including a certain command in the service information as a part of the information processing program for the personal cryptoprotective complexes, wherein said command is in the form of a typical set of symbols earlier inputted to the ROM, and storing the obtained electronic document in a section of the PROM provided in the personal cryptoprotective complex and intended for non-copied electronic documents. There are the steps of; in at least one of the personal cryptoprotective complexes: inputting a command 76 for simultaneous exchanging the electronic documents, and sending said command in the form of a signal 77 encrypted by means of the produced single-use encryption key to other personal cryptoprotective complex 35; in each of the personal cryptoprotective complexes, inputting a command to start transmission of the non-copied electronic document 60 and 75 recorded in the PROMs 13 to other subscriber of the established communication session; encrypting the electronic document with a dynamically transformable daughter code while reading an electronic document inability-for-copying command out of the service information; establishing protection against modification in the decrypted information and transmitting the encrypted information to other personal cryptoprotective complex; in accordance with the command 76 for simultaneous exchanging the electronic documents, and upon termination of transmission of the non-copied electronic document, disabling it in forms 61 and 78 for a predetermined time period T1 in the PROM 13 of the sender, receiving the electronic document and decrypting the electronic document; establishing the reliability of information by check for absence of distortions in information; searching for and selecting service information from the decrypted information by means of service symbols; using the service symbols to find service information containing the electronic document inability-for-copying command; recording the electronic document to the section of the PROM intended for non-copied electronic documents, disabling said electronic document for a predetermined time period T1 and outputting the obtained electronic document to the user for acquaintance. In the personal cryptoprotective complex of the receiving party, an electronic-document-loading-acknowledgement password 62 is generated and said electronic-document-loading-acknowledgement password is transmitted in the encrypted form to the personal cryptoprotective complex of the sending party. If the sender does not receive the electronic-document-loading-acknowledgement password from the recipient during the time period T1, the electronic document is enabled in the PROM of the personal cryptoprotective complex of the sender. If the recipient does not send the electronic-document-loading-acknowledgement password to the sender during the time period T1, there are the steps of deleting the electronic document from the PROM 13 of the personal cryptoprotective complex of the recipient; receiving the electronic-document-loading-acknowledgement 62 in the personal cryptoprotective complex of sending party, generating an electronic-document-transmission-acknowledgement password 63 and requesting a user acknowledgement 79 to send the present password to the personal cryptoprotective complex of the receiving party. In case if the user does not acknowledge the sending of the password during a predetermined time period T2, then, after the expiration of said time period, automatically enabling said electronic document in the PROM of the personal cryptoprotective complex of the sender, and automatically deleting said electronic document in the PROM of the personal cryptoprotective complex of the recipient. In case if the user gives the acknowledgement 79 for sending the password during the time period T2, then, sending a predetermined signal 80 in the encrypted form containing information of said acknowledgement to other user, and receiving the similar signal from said user. After the exchange of acknowledgement signals 80, there is synchronization according the last signal, and from the moment of sending a last bit of said signal from one of personal cryptoprotective complexes and to the moment of according reception thereof in other personal cryptoprotective complex a procedure of a simultaneous exchange of the electronic-document-transmission-acknowledgement passwords 63 in the encrypted form starts, wherein the reception of a password-containing signal from the opposite party is monitored in each of the personal cryptoprotective complexes, and in case of absence or interruption of said signal, the transmission of own password is stopped. After the sending of the transmission-acknowledgement password 63, said electronic document is automatically deleted from the PROM of the personal cryptoprotective complex of the sender, and when the recipient has received the electronic-document-transmission-acknowledgement password, said electronic document is automatically enabled in the PROM of the personal cryptoprotective complex of the recipient.

There are the following steps to improve safety in exchange of the copy-protected electronic documents 60 and 75: automatically introducing a time value T to the last acknowledgement signal 80, said value being different from a current time-reading by a time period t which value is generated by the random-number generator 20; sending the present signal to other user, and after the expiration of the signal sending time and before the time T comes, transmitting a random signal generated by the random-number generator 20; when the time T comes, automatically stopping transmission of the random signal and starting simultaneous transmission of electronic-document-transmission-acknowledgement passwords 63 in the encrypted form, said random signal and the cryptogram of passwords having identical characteristics. This technique allows avoidance of deliberated fail in transmission of last bytes of electronic-document-transmission-acknowledgement passwords, because the transmission termination time becomes unknown in this case.

The following method permits to guarantee simultaneous signing an electronic document with electronic digital signatures by at least two users through communications link. For this purpose, users make an exchange of a copy of the electronic document 60 preliminary signed by everyone with his or her own electronic digital signature, and after reception, disabling in the PROM 13 and acquaintance with the received electronic documents, at least one of users inputs a command of simultaneous signing the present electronic document; a signal in the encrypted form is sent to other user, said signal containing information on simultaneous signing the electronic document and being outputted to the user; after the exchange of the electronic-document-transmission-acknowledgement passwords 63, there is the step of automatically signing the electronic documents in each of the personal cryptoprotective complexes 34 and 35 with the electronic digital signature of the user. When parties have mutually signed the electronic document, the command of simultaneous signing the electronic document allows removal the protection against copying from the present electronic document for free acquaintance of any user with the present electronic document.

The information-processing program 22 (FIG. 14) of personal cryptoprotective complexes allows transmission of messages in an electronic letter mode at notice of reception of the electronic message by the addressee. Thus it is guaranteed that the addressee can read the message only under condition of reception by the sender of the electronic notice with the electronic signature of the addressee about his or her reception of the present electronic letter. For this purpose, the structure of the information processing program 22 includes a typical form of a notice sheet to which will automatically be put an electronic letter number generated by the random-number generator 20 prior to send the electronic letter, and an electronic signature of the user who is a recipient of the electronic letter. The message first received by the addressee is in the encrypted form from which the personal cryptoprotective complex of the recipient decrypts a service part of the message containing the electronic letter number and information that the present message is an electronic letter at notice. The procedure of sending and reception of the electronic letter at notice looks as follows: in one of the personal cryptoprotective complexes—34, inputting a command 86 to send the electronic letter at notice and inputting information; adding a number N-88 generated by the random-number generator 20 to the present information, separating said number by means of earlier inputted service symbols 47 and encrypting the information by said number with application of a decryption password 48; in accordance with said command 86, recording the decryption password 48 to the PROM 13 of the personal cryptoprotective complex 34 and marking said passwords with said number 88; generating the electronic letter at notice from the inputted encrypted information 45 and the service information 54 added thereto, separated with earlier inputted service symbols 47, containing the number 88 that corresponds to a number of information and the decryption password 48, and having a command included therein and indicating that the present information is an electronic letter at notice. Then there are the steps of: outputting a copy of the encrypted electronic letter at notice for record to the medium; establishing a cryptoprotective communication session with the certain user 35 using the personal cryptoprotective complexes, and transmitting the electronic letter 87 at notice; receiving information; decrypting the service information, finding the number 88 to be recorded to the PROM 13, and a command that the received encrypted information is an electronic letter at notice; and outputting the present command to the user 89. In accordance with said command and a command 90 inputted by the recipient—to send a notice on reception of said message to the sender, there are the steps of: generating the electronic document in the form of a preliminary inputted typical notice sheet 92; inputting the number 88 to said sheet, said number corresponding to a number of the received information; and signing the present electronic document with the electronic signature 24 of the user, said signature containing the current date and time; sending a predetermined signal 91 in the encrypted form to other user, said signal containing information that acknowledges presence of the notice. There are the following steps after the sending and respective reception of said signal 91: simultaneous changing the electronic notice sheet for the electronic letter decryption password 48; receiving the electronic letter decryption password 48 to the personal cryptoprotective complex 35 of the recipient; using said password to decrypt information received in the electronic letter 87 at notice and outputting said information to the user; receiving the electronic document being the notice-of-reception sheet of the electronic letter at notice to the personal cryptoprotective complex 34 of the sender; decrypting said electronic document and inputting it to the user and recording a cryptogram of the notice sheet to the medium.

If e-mail is used to send the electronic letter at notice, a node computer (server) is used with a node cryptoprotective complex connected thereto. Further, there are the following steps: in the personal cryptoprotective complex of the sender, inputting a command to send the electronic letter at notice and inputting information; adding a number N-88 generated by the random-number generator 20, to the present information, separating said number by means of earlier inputted service symbols 47, inputting an individual number I-19 of the personal cryptoprotective complex of the addressee, producing a random number Z-36; based on the inputted number I and the random number Z, encrypting the information, including the added random number N-88; in accordance with said command, recording the random number Z to the PROM 13 of the personal cryptoprotective complex 34 and marking it with said random number N; generating the electronic letter at notice from the inputted encrypted information and service information added thereto, separated with earlier inputted service symbols 47, containing the number that corresponds to the number N of information, and having a command included therein and indicating that the present information is an electronic letter at notice; outputting a copy of the encrypted electronic letter at notice for record to the medium; transmitting the electronic letter at notice to the node computer, establishing a cryptoprotective communication session with a node cryptoprotective complex connected to the node computer, transmitting the random number Z-36 to be stored in the node cryptoprotective complex; receiving the electronic letter at notice from the node computer to the personal cryptoprotective complex 35 of the addressee, decrypting the service information, finding the number N to be recorded to the PROM 13, and a command that the received encrypted information is an electronic letter at notice; and outputting the present command to the user. In accordance with said command and a command inputted by the recipient—to send a notice on reception of said message to the sender, there are the steps of: generating the electronic document in the form of a preliminary inputted typical notice sheet; inputting the number N to said sheet, said number corresponding to a number of the received information; and signing the present electronic document with the electronic signature of the user, said signature containing the current date and time; sending a predetermined signal in the encrypted form to the node cryptoprotective complex via the node computer, said signal containing information that acknowledges presence of the notice; there are the following steps after the sending and respective reception of said signal: simultaneous changing the electronic notice sheet for the random number Z-36; receiving the random number Z-36 to the personal cryptoprotective complex 35 of the recipient, outputting the individual number I-19 of the personal cryptoprotective complex and generating a single-use decryption key 38 of the basis of said numbers; decrypting information received in the electronic letter at notice and outputting said information to the user. Next, in the personal cryptoprotective complex 34 of the sender there are the steps of receiving the electronic document being the notice-of-reception sheet of the electronic letter at notice to the personal cryptoprotective complex of the sender from the node cryptoprotective complex via the node computer; decrypting said electronic document and inputting it to the user and recording a cryptogram of the notice sheet to the medium.

Application of personal cryptoprotective complexes for settlements in electronic bank bills and electronic cash permits to convert the present means of settlement into electronic money of incompatible payment systems. And, with a view of safety, the procedure of converting has unidirectional character, i.e. the backward converting of electronic money from plastic cards into electronic cash or electronic bills is undesirable. To realize the procedure of converting, the user will need a plastic card reader compatible with a personal cryptoprotective complex. Besides, the present procedure is feasible only after certain interactions of personal cryptoprotective complexes of a user and a bank having said user as a client, exactly, if it is supposed to convert electronic cash or unlimited electronic bank bills, there are the steps of:

Generating an electronic document in a personal cryptoprotective complex of a bank by means of a program included in structure of the information processing program 22 with application of predetermined service symbols 47, said document being intended for a certain user and including an electronic banknote signed by band and conditions of the bank in the form of certain commands; establishing a cryptoprotective communication session between the bank and the user with application of personal cryptoprotective complexes; and transmitting the generated electronic document to the user. Then, there are the steps of: receiving said electronic document to the personal cryptoprotective complex of the user and decrypting the electronic document, determining service symbols 47, using them to determine commands and the electronic banknote signed by bank, recording the electronic banknote to the PROM 13 of the personal cryptoprotective complex and disabling (freezing) said banknote till reception of certain commands and conformity with conditions of the bank contained in received commands of the electronic document. Then, there are the steps of: receiving electronic cash or electronic bank bills to the personal cryptoprotective complex of the user; inputting a user's command to enable (defreeze) the electronic banknote signed by bank; in accordance with the user's command, checking the PROM 13 for presence of electronic cash or electronic bank bills and their conformity with the conditions of the bank in the sum, currency and other attributes; in case of conformity with the conditions of the bank, disabling (freezing) the sum of electronic cash or electronic bank bills determined by the present condition and simultaneously enabling (de-freezing) the electronic banknote, wherein the sum of disabled (frozen) electronic cash or bills according to the conditions of the bank may exceed the sum of the electronic banknote. Next, there are the steps of: connecting a medium (a plastic card) to the personal cryptoprotective complex of the user by means of the terminal 2 and transmitting the electronic banknote to the present medium, making a payment transaction by said electronic banknote with use of the present medium; in the bank, receiving the present electronic banknote, put it into a register, and in case if denomination of the electronic banknote is higher than the sum of payment, refunding change to the medium of the user, billing the sum of the spent electronic banknote minus change to the bank account of the user from the moment of making the transaction, and simultaneously inputting information of an amount of credit in the form of predetermined commands to the personal cryptoprotective complex of the bank. Then, there are the steps of: connecting the personal cryptoprotective complex of the user to the personal cryptoprotective complex of the bank, establishing a cryptoprotective communication session between them, identifying the personal cryptoprotective complexes and inputting a command for repayment of the credit; calculating the sum for enabling in accordance with the sum and term of the credit; enabling (de-freezing) the sum of electronic cash or electronic bank bills determined by calculation; transmitting the sum necessary for repayment of the credit to the personal cryptoprotective complex of the bank while the residuary part of the enabled (de-frozen) sum remains at the order of the user.

If it is supposed to convert urgent or unlimited electronic bank bills, the following procedures take place. Using a program preliminary incorporated in structure of the information processing program 22 in the personal cryptoprotective complex of the bank, an electronic document is generated with application of predetermined service symbols 47, said document being intended for a certain user and include an electronic banknote signed by the bank, conditions of the bank in the form of certain commands; next, there are the steps of: establishing a cryptoprotective communication session between the bank and the user with application of the personal cryptoprotective complexes, and transmitting the generated electronic document to the user; receiving said electronic document to the personal cryptoprotective complex of the user and decrypting it, determining service symbols 47, using said symbols to determine commands and the electronic banknote signed by the bank; recording the electronic banknote to the PROM 13 of the personal cryptoprotective complex and disabling (freezing) it till reception of certain commands and conformity with the conditions of the bank contained in received commands of the electronic document. Next, there are the steps of: receiving electronic bank bills to the personal cryptoprotective complex of the user from a personal cryptoprotective complex of other user; inputting a user's command to enable (defreeze) the electronic banknote signed by bank. Then, there are the steps of: in accordance with the user's command, checking the PROM 13 for presence of an electronic bank bill and its conformity with the conditions of the bank in the sum, currency and other attributes; reading data 24 of the user to which the electronic bill was addressed, said data including individual number 19 of the personal cryptoprotective complex of said user. If the electronic bill is in conformity with the conditions of the bank, there are the steps of: enabling (de-freezing) the electronic banknote with simultaneous reduction of a face value of said electronic bill by the sum corresponding to the sum of the electronic banknote, wherein the encrypted information containing the user's data 24 and 19 taken from said electronic bill is added to the electronic banknote; connecting a medium (a plastic card) to the personal cryptoprotective complex of the user by means of the terminal 2 and transmitting the electronic banknote to the present medium. Next, there are the steps of: making a payment transaction by said electronic banknote with use of the present medium; in the bank, receiving the present electronic banknote and decrypting information added thereto; from said information, determining a user account where a mortgage amount on said electronic bill is stored and writing-off a sum from said amount, said sum corresponding to the received electronic banknote; putting the electronic banknote into a register, and if denomination of the electronic banknote is higher than the sum of payment, refunding change to the medium of the user.

When the user's data 24, including the number 19 of the personal cryptoprotective complex of the user and contained in the electronic bill, coincides with similar data in the ROM 17 of the personal cryptoprotective complex of the user, there are the steps of: enabling (de-freezing) the electronic banknote including a user account number, with simultaneous reduction of a face value of said electronic bill by the sum corresponding to the sum of the electronic banknote; connecting the medium to the personal cryptoprotective complex of the user by means of the terminal and transmitting the electronic banknote to the present medium without addition of additional data to the electronic banknote.

Next there are the steps of: making a payment transaction by means of the present medium; in the bank, receiving the present electronic banknote; determining from said banknote a user account where a mortgage amount on said electronic bill is stored, and writing-off a sum from said amount, said sum corresponding to the received electronic banknote; putting the electronic banknote into a register, and if denomination of the electronic banknote is higher than the sum of payment, refunding change to the medium of the user.

### INDUSTRIAL APPLICABILITY

The system may be realized on the base of a RISC processor, and on the basis of processors Intel 80x86 for protection of computer programs against the non-authorized copying. The system as a whole may be realized on the basis of IBM PC by embedding a microprocessor, a RAM, a clock and an accumulator of a personal computer into the protective optical sheath provided with a built-in cryptokernel.

1-55. (canceled)

56. A method for transmission of information with protection against copying with use of a personal cryptoprotective complex, the method comprising:
in a ROM of each of personal cryptoprotective complexes, storing copies of a mother code being a set of random numbers (M1, M2, . . . , MN), encryption, decryption and information processing programs, wherein record is carried out in a protected way only in said personal cryptoprotective complexes, said way excluding the possibility of recording to other media and modifying said programs, as well as personal data of a user including his or her electronic signature and other attributes used for execution of cryptoprotective operations and generation of electronic documents, and setting date and time in a built-in clock;
in the input of user's information to the personal cryptoprotective complex, inputting user's commands to establish a mode of processing the user's information, to generate a non-copied electronic document, and processing the inputted user's information;
in accordance with the established mode of processing the user's information and the earlier received information, generating service information by means of the information processing program, and combining the service information with the processed user's information to obtain an electronic document, attributes of the electronic document in the form of service information being separated from the processed user's information by means of service symbols, and in accordance with a user's command to generate a non-copied electronic document, including a command in the service information, said command being intended for the personal cryptoprotective complexes and being in the form of a typical set of symbols inputted earlier to the ROM in structure of the information processing program, and storing the obtained electronic document in a section of the ROM intended for non-copied electronic documents of the personal cryptoprotective complex;
establishing a protected communication session with application of the personal cryptoprotective complexes on the basis of a single-use key of the communication session generated using random numbers, and inputting a user's command to transmit the non-copied electronic document recorded in the PROM to other subscriber of the established communication session;
encrypting the electronic document by a dynamically transformable daughter code while reading an electronic document inability-for-copying command out of the service information, establishing the protection against modification to the encrypted information, and transmitting the encrypted information to another personal cryptoprotective complex;
upon termination of transmission of the non-copied electronic document, disabling it for a predetermined time period T1 in the PROM according to said inability-for-copying command;
receiving the electronic document and decrypting the electronic document, establishing the reliability of information by check for absence of distortions in said information, searching for and selecting service information from decrypted information by means of service symbols, using the service symbols to find the service information containing the electronic document inability-for-copying command, recording the electronic document to the section of the PROM intended for non-copied electronic documents, and disabling said document for the predetermined time period T1;
generating an electronic-document-loading-acknowledgement password in the personal cryptoprotective complex of a receiving party and transmitting the electronic-document-loading-acknowledgement password in the encrypted form to the personal cryptoprotective complex of a sending party;
in case if the sender does not receive the electronic-document-loading-acknowledgement password from the recipient during the time period T1, enabling the electronic document in the PROM of the personal cryptoprotective complex of the sender, while ignoring the subsequent reception of said password;
in case if the recipient does not send the electronic-document-loading-acknowledgement password to the sender during the time period T1, deleting the electronic document from the PROM of the personal cryptoprotective complex;
receiving the electronic-document-loading-acknowledgement password in the personal cryptoprotective complex of the sending party, generating an electronic-document-transmission-acknowledgement password, and requesting a user acknowledgement in response to the sending of the present password to the personal cryptoprotective complex of the receiving party;
in case if the user gives no acknowledge in response to the sending of the password during a predetermined time period T2, then, on the expiration of said time period, automatically enabling said electronic document in the PROM of the personal cryptoprotective complex of the sender, and automatically deleting said electronic document in the PROM of the personal cryptoprotective complex of the recipient;
in case if the user acknowledges the sending of the password during the time period T2, sending the present password in the encrypted form to the personal cryptoprotective complex of the recipient, wherein said electronic document is automatically deleted from PROM of the personal cryptoprotective complex of the sender, and said electronic document is automatically enabled in the PROM of the personal cryptoprotective complex of the recipient when he or she has received said electronic-document-transmission-acknowledgement password, followed by inputting user's commands, establishing a mode of processing the decrypted information according to the user's commands received from the service information and according to the earlier inputted information and the information processing program, and outputting the processed information to the user together with service symbols that authenticate attributes of the received electronic document.

57. The method according to claim 56, further comprising:
receiving decrypted information to the personal cryptoprotective complex, said information being the non-copied electronic document containing a variable face value denoted in a predetermined way by service symbols;
decrypting said information and recording the received electronic document to the ROM of the personal cryptoprotective complex;
determining service symbols in the electronic document by means of the information-processing program;
determining a variable face value information of the electronic document in service information, and outputting said variable face value information to the user;
subdividing the electronic document into arbitrary parts by changing face values of parts using the information processing program in such a manner that their total sum remains invariable, wherein other characteristics and attributes of parts of the electronic document also remain unchangeable;
sending parts of the electronic document to other personal cryptoprotective complexes;
receiving several identical electronic documents with variable face values to the personal cryptoprotective complex and automatically collecting said documents using the information-processing program into a unified electronic document by summing their face values.

58. The method according to claim 57, wherein the electronic document with a variable face value is an electronic bank bill of exchange with a predetermined time for repayment, wherein the service information of said bill contains data of a bank drawn the bill, including electronic digital signatures of the bank generated using a personal cryptoprotective complex, data of a user who has received the bill, currency and a face value of the bill as well as a bill repayment date after which the bank will enable a mortgage amount of money left at a user's account that will be transferred ahead of time to any holder of the present electronic bill or its part after reception of the electronic bill to the personal cryptoprotective complex of the bank, identify data of the electronic bill and determine its face value, and if the date of repayment indicated in the bill is not later than a current date, the holder will obtain the sum corresponding to the face value of the presented electronic bill.

59. The method according to claim 56, further comprising:
adding a temporary individual number generated by a random-number generator to the electronic document, and an arbitrary inputted value of the time period T2, said number and value being encrypted together with the electronic document;
inputting a command to transmit the electronic document to other user during the protected communication session or in the encrypted electronic letter;
when the transmission of the present electronic document terminates, disabling said document for a predetermined time period T1 in the PROM of the sender and marking said document with an assigned temporary individual number;
in case of failures in transmission of the electronic document, the sender repeatedly sends the present electronic document with the same accompanying data;
receiving the electronic document and decrypting the electronic document, establishing the reliability of information by check for absence of distortions in the information;
searching for and selecting service information from the decrypted information by means of service symbols, using service symbols to find service information containing an electronic document inability-for-copying command and the temporary individual number of the present document; collating said number for presence of a disabled electronic document having the same number in the PROM, and in case if coincidence is absent, recording the electronic document to the section of the PROM intended for non-copied electronic documents, marking it with the assigned temporary individual number and disabling the electronic document for the predetermined time period T1;
in the personal cryptoprotective complex of the receiving party, generating an electronic-document-loading-acknowledgement password on the basis of a random number, automatically adding said temporary individual number of the present electronic document to said password, recording a password to the PROM, and transmitting the electronic-document-loading-acknowledgement password in the encrypted form to the personal cryptoprotective complex of the sending party during the protected communication session or in the encrypted electronic letter;
receiving the electronic-document-loading-acknowledgement password in the personal cryptoprotective complex of the sending party, finding the disabled electronic document in the PROM, said document being marked by number corresponding to a number received with the password, and in case of presence of the disabled electronic document and coincidence of numbers there is the step of generating an electronic-document-transmission-acknowledgement password with use of electronic-document-loading-acknowledgement password, said temporary individual number of the electronic document being automatically included therein;
requesting a user acknowledgement for sending said password to the personal cryptoprotective complex of the receiving party;
in case if the user does not give acknowledgement for sending the password during an arbitrary time period T2 which value was inputted beforehand by the sender in establishment of an electronic document sending mode, then after the expiration of a predetermined period of time there are the steps of: automatically enabling said electronic document in the PROM of the personal cryptoprotective complex of the sender; and automatically deleting said electronic document in the PROM of the personal cryptoprotective complex of the recipient;
in case if the user gives acknowledgement for sending the password during the time period T2, then sending said password in the encrypted form to the personal cryptoprotective complex of the recipient, wherein said electronic document is automatically deleted from the PROM of the personal cryptoprotective complex of the sender, and when the recipient has received the electronic-document-transmission-acknowledgement password, there is the step of finding the disabled electronic document and the recorded copy of the electronic-document-loading-acknowledgement password in the PROM of the personal cryptoprotective complex of the recipient, said document and said copy being denoted by number corresponding the number received with the password, and only in case of presence of the disabled electronic document, coincidence of numbers and presence of a direct association between passwords, said electronic document is automatically enabled;
recording the electronic document to the section of the PROM of the personal cryptoprotective complex, intended for non-copied electronic documents and closed for users of the PROM, and deleting said temporary individual number;
in case of failures in transmission of the electronic document or acknowledgement passwords, users carry out the backup of transmission.

60. The method according to claim 59, further comprising:
adding an individual number N1 of the personal cryptoprotective complex where from the electronic-document-transmission-acknowledgement password will be sent, a temporary individual number N2 generated by the random-number generator, and an infinite value T2 of the time period to be inputted by the user, said number and value being encrypted together with the electronic document, to the transmittable electronic document;
inputting a command to transmit the electronic document to other user in process of the protected communication session;
when the transmission of the present electronic document terminates, enabling said document for a predetermined time period T1 in the PROM of the sender and marking said document with said assigned number N2;
receiving the electronic document and decrypting the electronic document, establishing the reliability of information by check for absence of distortion in information;
searching for and selecting service information from the decrypted information by means of service symbols, using said service symbols to find service information containing an electronic document inability-for-copying command and numbers of said document, recording the electronic document to the section of the PROM intended for non-copied electronic documents, marking said document with its assigned number N2 and disabling the electronic document for the predetermined time period T1;
in the personal cryptoprotective complex of the receiving party, generating the electronic-document-loading-acknowledgement, automatically adding said number N2 of the present electronic document to said password and transmitting the result in the encrypted form to the personal cryptoprotective complex of the sending party during the same or other protected communication session;
receiving the electronic-document-loading-acknowledgement of the electronic document in the personal cryptoprotective complex of the sending party, finding the disabled electronic document in the PROM, said document being marked by number N2 corresponding to the number received with the password, and in case of presence of the disabled electronic document and coincidence of numbers, deleting the present electronic document from the PROM, because the time period T2 is equal to an infinite value;
in the personal cryptoprotective complex whose individual number corresponds to the number N1 assigned to the electronic document, inputting a numerical value corresponding to the number N2 of the electronic document, generating the electronic-document-transmission-acknowledgement password while automatically including therein own individual number corresponding to N1 and the inputted number N2;
sending the present password in the encrypted to the personal cryptoprotective complex of the recipient of the electronic document;
when the personal cryptoprotective complex of the recipient has received the electronic-document-transmission-acknowledgement password in its PROM, finding the disabled electronic document marked by the number N2 corresponding to the number received with the password, collating the numbers N1 in the electronic document and in the password, and only if coincidence of numbers takes place, automatically enabling said electronic document;
recording the electronic document to the section of the PROM of the personal cryptoprotective complex, intended for non-copied electronic documents, and deleting the added numbers N1 and N2.

61. The method according to claim 59, further comprising:
adding the temporary individual number generated by the random-number generator and an infinite value T2 of the time period, said number and value being encrypted together with the electronic document, to the transmittable electronic document;
inputting a command to generate said electronic-document-transmission-acknowledgement password;
generating an electronic-document-acknowledgement password, assigning a number and a variable face value, if any, thereto, said number and variable face value corresponding to the temporary number and temporary face value of the electronic document;
transmitting the electronic-document-acknowledgement password in the encrypted form during a cryptoprotective communication session to a certain user or keeping said password in own personal cryptoprotective complex;
disabling the electronic document for an arbitrary time period T1 in the PROM of the personal cryptoprotective complex, making copies of the electronic document and transmitting them to other users in process of the cryptoprotective communication session or in an encrypted electronic letter;
after the expiration of the time period T1, deleting the electronic document from the PROM of the sender;
receiving copies of the electronic document, decrypting the electronic document, searching for and selecting service information from the decrypted information by means of service symbols; finding a mark that there is a copy of the electronic document, and a temporary individual number of the present document, recording the electronic document to the PROM and marking it with the assigned temporary individual number;
receiving the electronic-document-transmission-acknowledgement password to a personal cryptoprotective complex of a user who has received the electronic document copy, finding said electronic document copy marked with the number corresponding to the number received with the password in the PROM, and if the numbers coincide, removing the mark that there is a copy from the electronic document copy, and then recording the electronic document to the section of the PROM of the personal cryptoprotective complex, intended for non-copied electronic documents and closed for users of the PROM, and deleting said temporary individual number;
after the transmission of said password, deleting it from the PROM in the personal cryptoprotective complex of the sender of the electronic-document-transmission-acknowledgement password, and if a part of the password is transmitted with a variable face value, decreasing a face value of a part of said password residuary in the PROM by the sum equal to the transmitted part.

62. A method for transmission of information with protection against copying with use of a personal cryptoprotective complex, the method comprising:
in a ROM of each of personal cryptoprotective complexes, storing copies of a mother code being a set of random numbers (M1, M2, . . . , MN), encryption, decryption and information processing programs, wherein record is carried out in a protected way only in said personal cryptoprotective complexes, said way excluding the possibility of recording to other media and modifying said programs;
storing an individual number of the personal cryptoprotective complex as well as other attributes used for execution of cryptoprotective operations in the ROM and setting date and time in a built-in clock;
generating a decryption password on the basis of a random number and recording it to a section of a PROM intended for non-copied decryption passwords and closed for users;
generating a dynamically transformable daughter code on the basis of the mother code and the decryption password;
inputting information, including a computer program, to the personal cryptoprotective complex, and making its encryption using said decryption password;
outputting the encrypted information to a user for record to a medium or for transmission to other user;
inputting a command to transmit the decryption password to other user in process of the protected communication session;
encrypting the decryption password on the basis of a single-use key generated using at least one random number, and outputting said password for transmission;
according to the fact that the decryption password has the status of a non-copied electronic document, upon termination of transmission of the present electronic document, disabling it for a predetermined time period T1 in the PROM;
receiving the electronic document and decrypting the electronic document, establishing the reliability of information by check for absence of distortions in said information, searching for and selecting service information from decrypted information by means of service symbols, using the service symbols to find the service information containing an electronic document inability-for-copying command, recording the electronic document to the section of the PROM intended for non-copied electronic documents, and disabling said document for the predetermined time period T2;
generating an electronic-document-loading-acknowledgement password in the personal cryptoprotective complex of a receiving party and transmitting the electronic-document-loading-acknowledgement password in the encrypted form to the personal cryptoprotective complex of a sending party;
in case if the sender does not receive the electronic-document-loading-acknowledgement password from the recipient during the time period T1, enabling the electronic document in the PROM of the personal cryptoprotective complex of the sender, while ignoring the subsequent reception of said password;
in case if the recipient does not send the electronic-document-loading-acknowledgement password to the sender during the time period T1, deleting the electronic document from the PROM of the personal cryptoprotective complex;
receiving the electronic-document-loading-acknowledgement password in the personal cryptoprotective complex of the sending party, generating an electronic-document-transmission-acknowledgement password, and requesting a user acknowledgement in response to the sending of the present password to the personal cryptoprotective complex of the receiving party;
in case if the user gives no acknowledge in response to the sending of the password during the predetermined time period T2, then, on the expiration of said time period, automatically enabling said electronic document in the PROM of the personal cryptoprotective complex of the sender, and automatically deleting said electronic document in the PROM of the personal cryptoprotective complex of the recipient;
in case if the user acknowledges the sending of the password during the time period T2, sending the present password in the encrypted form to the personal cryptoprotective complex of the recipient, wherein said electronic document is automatically deleted from PROM of the personal cryptoprotective complex of the sender, and said electronic document is automatically enabled in the PROM of the personal cryptoprotective complex of the recipient when he or she has received said electronic-document-transmission-acknowledgement password;
recording the decryption password to the section of the PROM intended for non-copied electronic documents and closed for users of the PROM;
inputting information, including a computer program, to the personal cryptoprotective complex and decryption said information on the basis of the dynamically transformable code generated using the decryption password read out of the PROM;
in case of decryption of a computer program, connecting the personal cryptoprotective complex to a computer, recording a decrypted fragment of the program to a RAM of the personal cryptoprotective complex, executing only a part of operations in a microprocessor of the personal cryptoprotective complex compatible to the computer, while executing another part in the microprocessor of the computer.

63. The method according to claim 62, further comprising:
inputting a user's command to limit a validity period of the decryption password in time or quantity of events of use;
including appropriate service commands in the decryption password and selecting them by means of service symbols;
encrypting the received service commands in structure of the decryption password, and outputting them for the further record to a medium or transmission to other user while storing the decryption password in the PROM,
simultaneously disabling the access to the decryption password residuary in the PROM of the personal cryptoprotective complex of the user for a predetermined time interval;
inputting or accordingly receiving the encrypted decryption password with service commands included therein;
selecting service commands by means of service symbols, and executing operations with the present decryption password according to the received commands from the service information, exactly: deleting the decryption password from the memory of the personal cryptoprotective complex after the expiration of time pointed in the service information or after use of the decryption password as much times as indicated in the service information.

64. The method according to claim 62, further comprising:
inputting a command to transmit the decryption password to other user in an encrypted electronic letter;
adding service information separated by means of service symbols to the decryption password, with the indication of the individual number of the personal cryptoprotective complex of the recipient, and also of date and time after which expiration the recipient of the present decryption password can transmit said password to other users of personal cryptoprotective complexes;
simultaneously, generating an electronic letter in the personal cryptoprotective complex of the sender of the decryption password, said letter including the decryption password with the service information added thereto, with additional indication of the date and time in the form of service information as well, and the personal cryptoprotective complex of the electronic letter recipient will be able to decrypt said message only before the expiration of said date and time, wherein the date and time of decrypting the electronic letter should be indicated earlier than or identical to the date and time indicated in the service information of the decryption password;
encrypting the generated electronic letter with the dynamically transferable code based on the single-use key generated from a random number and the individual number of the personal cryptoprotective complex of the recipient of the present electronic letter, and adding said random number to the encrypted electronic letter;
outputting the encrypted electronic letter and the random number for transmission to the addressee together with information decrypted by means of the decryption password;
recording the encrypted electronic letter containing the decryption password together with the random number to a medium or transmitting said letter through a communication link, and upon termination of transmission, deleting the encryption password from the PROM of the personal cryptoprotective complex of the sender;
receiving the encrypted electronic letter, the random number and the encrypted information;
inputting the random number to the RAM of the personal cryptoprotective complex, and reading the individual number of the personal cryptoprotective complex out of the ROM and recording it to the RAM as well;
generating a single-use key on the basis of the inputted random number and the read-out individual number;
generating the dynamically transformable code on the basis of the single-use key and inputting the encrypted electronic letter to the personal cryptoprotective complex;
decrypting the electronic letter using the dynamically transformable code and recording the decrypted text of the electronic letter to the RAM;
defining service information by means of service symbols, finding the service information with indication of the final date and time of decrypting the electronic letter and collating them with the date and time in the built-in clock, and in case if the final date and time are later than the current date and time, deleting the present electronic letter from the RAM;
finding the decryption password, which includes the date and time after which expiration the decryption password may be transmitted to other users, and recording said decryption password to the section of the PROM of the personal cryptoprotective complex, intended for non-copied decryption passwords and closed for users of the PROM;
inputting information, including a computer program, to the personal cryptoprotective complex and decrypting said information on the basis of the dynamically transformable code generated using the decryption password read out of the PROM;
wherein, after the expiration of date and time pointed in the service information included in the decryption password, deleting the present service information from the PROM, with simultaneous removal of the restriction on the further transmission of the decryption password to other users.

65. The method according to claim 62, further comprising:
adding a temporary individual number generated by a random-number generator to the electronic document, and an arbitrary inputted value of the time period T2, said number and value being encrypted together with the electronic document;
inputting a command to transmit the electronic document to other user during the protected communication session or in the encrypted electronic letter;
when the transmission of the present electronic document terminates, disabling said document for a predetermined time period T1 in the PROM of the sender and marking said document with an assigned temporary individual number;
in case of failures in transmission of the electronic document, the sender repeatedly sends the present electronic document with the same accompanying data;
receiving the electronic document and decrypting the electronic document, establishing the reliability of information by check for absence of distortions in the information;
searching for and selecting service information from the decrypted information by means of service symbols, using service symbols to find service information containing an electronic document inability-for-copying command and the temporary individual number of the present document; collating said number for presence of a disabled electronic document having the same number in the PROM, and in case if coincidence is absent, recording the electronic document to the section of the PROM intended for non-copied electronic documents, marking it with the assigned temporary individual number and disabling the electronic document for the predetermined time period T1;
in the personal cryptoprotective complex of the receiving party, generating an electronic-document-loading-acknowledgement password on the basis of a random number, automatically adding said temporary individual number of the present electronic document to said password, recording a password to the PROM, and transmitting the electronic-document-loading-acknowledgement password in the encrypted form to the personal cryptoprotective complex of the sending party during the protected communication session or in the encrypted electronic letter;
receiving the electronic-document-loading-acknowledgement password in the personal cryptoprotective complex of the sending party, finding the disabled electronic document in the PROM, said document being marked by number corresponding to a number received with the password, and in case of presence of the disabled electronic document and coincidence of numbers there is the step of generating an electronic-document-transmission-acknowledgement password with use of electronic-document-loading-acknowledgement password, said temporary individual number of the electronic document being automatically included therein;
requesting a user acknowledgement for sending said password to the personal cryptoprotective complex of the receiving party;
in case if the user does not give acknowledgement for sending the password during an arbitrary time period T2 which value was inputted beforehand by the sender in establishment of an electronic document sending mode, then after the expiration of a predetermined period of time there are the steps of: automatically enabling said electronic document in the PROM of the personal cryptoprotective complex of the sender; and automatically deleting said electronic document in the PROM of the personal cryptoprotective complex of the recipient;
in case if the user gives acknowledgement for sending the password during the time period T2, then sending said password in the encrypted form to the personal cryptoprotective complex of the recipient, wherein said electronic document is automatically deleted from the PROM of the personal cryptoprotective complex of the sender, and when the recipient has received the electronic-document-transmission-acknowledgement password, there is the step of finding the disabled electronic document and the recorded copy of the electronic-document-loading-acknowledgement password in the PROM of the personal cryptoprotective complex of the recipient, said document and said copy being denoted by number corresponding the number received with the password, and only in case of presence of the disabled electronic document, coincidence of numbers and presence of a direct association between passwords, said electronic document is automatically enabled;
recording the electronic document to the section of the PROM of the personal cryptoprotective complex, intended for non-copied electronic documents and closed for users of the PROM, and deleting said temporary individual number;
in case of failures in transmission of the electronic document or acknowledgement passwords, users carry out the backup of transmission.

66. The method according to claim 65, further comprising:
adding an individual number N1 of the personal cryptoprotective complex where from the electronic-document-transmission-acknowledgement password will be sent, a temporary individual number N2 generated by the random-number generator, and an infinite value T2 of the time period to be inputted by the user, said number and value being encrypted together with the electronic document, to the transmittable electronic document;
inputting a command to transmit the electronic document to other user in process of the protected communication session;
when the transmission of the present electronic document terminates, enabling said document for a predetermined time period T1 in the PROM of the sender and marking said document with said assigned number N2;
receiving the electronic document and decrypting the electronic document, establishing the reliability of information by check for absence of distortion in information;
searching for and selecting service information from the decrypted information by means of service symbols, using said service symbols to find service information containing an electronic document inability-for-copying command and numbers of said document, recording the electronic document to the section of the PROM intended for non-copied electronic documents, marking said document with its assigned number N2 and disabling the electronic document for the predetermined time period T1;
in the personal cryptoprotective complex of the receiving party, generating the electronic-document-loading-acknowledgement, automatically adding said number N2 of the present electronic document to said password and transmitting the result in the encrypted form to the personal cryptoprotective complex of the sending party during the same or other protected communication session;
receiving the electronic-document-loading-acknowledgement of the electronic document in the personal cryptoprotective complex of the sending party, finding the disabled electronic document in the PROM, said document being marked by number N2 corresponding to the number received with the password, and in case of presence of the disabled electronic document and coincidence of numbers, deleting the present electronic document from the PROM, because the time period T2 is equal to an infinite value;
in the personal cryptoprotective complex whose individual number corresponds to the number N1 assigned to the electronic document, inputting a numerical value corresponding to the number N2 of the electronic document, generating the electronic-document-transmission-acknowledgement password while automatically including therein own individual number corresponding to N1 and the inputted number N2;
sending the present password in the encrypted to the personal cryptoprotective complex of the recipient of the electronic document;
when the personal cryptoprotective complex of the recipient has received the electronic-document-transmission-acknowledgement password in its PROM, finding the disabled electronic document marked by the number N2 corresponding to the number received with the password, collating the numbers N1 in the electronic document and in the password, and only if coincidence of numbers takes place, automatically enabling said electronic document;
recording the electronic document to the section of the PROM of the personal cryptoprotective complex, intended for non-copied electronic documents, and deleting the added numbers N1 and N2.

67. The method according to claim 65, further comprising:
adding the temporary individual number generated by the random-number generator and an infinite value T2 of the time period, said number and value being encrypted together with the electronic document, to the transmittable electronic document;
inputting a command to generate said electronic-document-transmission-acknowledgement password;
generating an electronic-document-acknowledgement password, assigning a number and a variable face value, if any, thereto, said number and variable face value corresponding to the temporary number and temporary face value of the electronic document;
transmitting the electronic-document-acknowledgement password in the encrypted form during a cryptoprotective communication session to a certain user or keeping said password in own personal cryptoprotective complex;
disabling the electronic document for an arbitrary time period T1 in the PROM of the personal cryptoprotective complex, making copies of the electronic document and transmitting them to other users in process of the cryptoprotective communication session or in an encrypted electronic letter;
after the expiration of the time period T1, deleting the electronic document from the PROM of the sender;
receiving copies of the electronic document, decrypting the electronic document, searching for and selecting service information from the decrypted information by means of service symbols; finding a mark that there is a copy of the electronic document, and a temporary individual number of the present document, recording the electronic document to the PROM and marking it with the assigned temporary individual number;
receiving the electronic-document-transmission-acknowledgement password to a personal cryptoprotective complex of a user who has received the electronic document copy, finding said electronic document copy marked with the number corresponding to the number received with the password in the PROM, and if the numbers coincide, removing the mark that there is a copy from the electronic document copy, and then recording the electronic document to the section of the PROM of the personal cryptoprotective complex, intended for non-copied electronic documents and closed for users of the PROM, and deleting said temporary individual number;
after the transmission of said password, deleting it from the PROM in the personal cryptoprotective complex of the sender of the electronic-document-transmission-acknowledgement password, and if a part of the password is transmitted with a variable face value, decreasing a face value of a part of said password residuary in the PROM by the sum equal to the transmitted part.

68. A method for simultaneously exchanging copy-protected electronic documents among users through a communication link with use of a cryptoprotective complex, comprising:
in a ROM of each of personal cryptoprotective complexes, storing copies of a mother code being a set of random numbers (M1, M2, . . . , MN), encryption, decryption and information processing programs, wherein record is carried out in a protected way only in said personal cryptoprotective complexes, said way excluding the possibility of recording to other media and modifying said programs;
storing an individual number I of the personal cryptoprotective complex in the ROM as well as personal data of a user including his or her electronic signature and other attributes used for execution of cryptoprotective operations and generation of electronic documents, and setting date and time in a built-in clock;
synchronously generating a single-use encryption key on the basis of random numbers produced in the personal cryptoprotective complexes of users;
synchronously generating dynamically transformable daughter codes on the basis of the mother code and the single-use encryption key in the personal cryptoprotective complexes of users;
inputting initial information to each of the personal cryptoprotective complexes of users; in accordance with an established mode of processing user's information and earlier received information, generating service information by means of the information processing program and combining the service information with the processed user's information to obtain an electronic document, wherein attributes of the electronic document in the form of service information are separated from the processed user's information by means of predetermined service symbols, and in accordance with a user's command to generate a copy-protected electronic document, including a certain command in the service information as a part of the information processing program for the personal cryptoprotective complexes, wherein said command is in the form of a typical set of symbols earlier inputted to the ROM, and storing the obtained electronic document in a section of the PROM provided in the personal cryptoprotective complex and intended for non-copied electronic documents;
in at least one of the personal cryptoprotective complexes, inputting a command for simultaneous exchanging the electronic documents, and sending said command in the form of a signal encrypted by means of the produced single-use encryption key to other personal cryptoprotective complex;
in each of the personal cryptoprotective complexes, inputting a command to start transmission of the non-copied electronic document recorded in the PROM to other subscriber of the established communication session;
encrypting the electronic document with a dynamically transformable daughter code while reading an electronic document inability-for-copying command out of the service information;
establishing protection against modification in the decrypted information and transmitting the encrypted information to other personal cryptoprotective complex;
in accordance with the command for simultaneous exchanging the electronic documents, and upon termination of transmission of the non-copied electronic document, disabling it for a predetermined time period T1 in the PROM of the sender;
receiving the electronic document and decrypting the electronic document, establishing the reliability of information by check for absence of distortions in information;
searching for and selecting service information from the decrypted information by means of service symbols, using the service symbols to find service information containing the electronic document inability-for-copying command, recording the electronic document to the section of the PROM intended for non-copied electronic documents, disabling said electronic document for a predetermined time period T1 and outputting the obtained electronic document to the user for acquaintance;
in the personal cryptoprotective complex of the receiving party, generating an electronic-document-loading-acknowledgement password and transmitting said electronic-document-loading-acknowledgement password in the encrypted form to the personal cryptoprotective complex of the sending party;
if the sender does not receive the electronic-document-loading-acknowledgement password from the recipient during the time period T1, the electronic document is enabled in the PROM of the personal cryptoprotective complex of the sender;
if the recipient does not send the electronic-document-loading-acknowledgement password to the sender during the time period T1, deleting the electronic document from the PROM of the personal cryptoprotective complex of the recipient;
receiving the electronic-document-loading-acknowledgement in the personal cryptoprotective complex of sending party, generating an electronic-document-transmission-acknowledgement password and requesting a user acknowledgement to send the present password to the personal cryptoprotective complex of the receiving party;
in case if the user does not acknowledge the sending of the password during a predetermined time period T2, then, after the expiration of said time period, automatically enabling said electronic document in the PROM of the personal cryptoprotective complex of the sender, and automatically deleting said electronic document in the PROM of the personal cryptoprotective complex of the recipient;
in case if the user gives the acknowledgement for sending the password during the time period T2, then, sending a predetermined signal in the encrypted form containing information of said acknowledgement to other user, and receiving the similar signal from said user;
after the exchange of acknowledgement signals, making synchronization according the last signal, and from the moment of sending a last bit of said signal from one of personal cryptoprotective complexes and to the moment of according reception thereof in other personal cryptoprotective complex, starting a procedure of a simultaneous exchange of the electronic-document-transmission-acknowledgement passwords in the encrypted form, wherein the reception of a password-containing signal from the opposite party is monitored in each of the personal cryptoprotective complexes, and in case of absence or interruption of said signal, the transmission of own password is stopped;
after the sending of the transmission-acknowledgement password, automatically deleting said electronic document from the PROM of the personal cryptoprotective complex of the sender, and when the recipient has received the electronic-document-transmission-acknowledgement password, automatically enabling said electronic document in the PROM of the personal cryptoprotective complex of the recipient.

69. The method according to claim 68, further comprising:
automatically introducing a time value T to the last acknowledgement signal, said value being different from a current time-reading by a time period t which value is generated by the random-number generator;
sending the present signal to other user, and after the expiration of the signal sending time and before the time T comes, transmitting a random signal generated by the random-number generator;
when the time T comes, automatically stopping transmission of the random signal and starting simultaneous transmission of electronic-document-transmission-acknowledgement passwords in the encrypted form, said random signal and the cryptogram of passwords having identical characteristics.

70. The method according to claim 68, wherein
users make an exchange of a copy of the electronic document preliminary signed by everyone with his or her own electronic digital signature, and after reception, disabling in the PROM and acquaintance with the received electronic documents, at least one of users inputs a command of simultaneous signing the present electronic document;
a signal in the encrypted form is sent to other user, said signal containing information on simultaneous signing the electronic document and being outputted to the user;
after the exchange of the electronic-document-transmission-acknowledgement passwords, there is the step of automatically signing the electronic documents in each of the personal cryptoprotective complexes with the electronic digital signature of the user.

71. The method according to claim 68, further comprising:
inputting, in one of the personal cryptoprotective complexes, a command to send an electronic letter at notice and inputting information, adding a number generated by the random-number generator to the present information, separating said number by means of earlier inputted service symbols and encrypting the information by said number with application of a decryption password;
in accordance with said command, recording the decryption password to the PROM of the personal cryptoprotective complex and marking said passwords with said number;
generating the electronic letter at notice from the inputted encrypted information and the service information added thereto, separated with earlier inputted service symbols, containing the number that corresponds to a number of information and the decryption password, and having a command included therein and indicating that the present information is an electronic letter at notice, outputting a copy of the encrypted electronic letter at notice for record to a medium;
establishing a cryptoprotective communication session with a certain user using the personal cryptoprotective complexes, and transmitting the electronic letter at notice;
receiving information; decrypting the service information, finding the number to be recorded to the PROM, and a command that the received encrypted information is an electronic letter at notice, and outputting the present command to the user;
in accordance with said command and a command inputted by the recipient—to send a notice on reception of said message to the sender, generating the electronic document in the form of a preliminary inputted typical notice sheet, inputting the number to said sheet, said number corresponding to a number of the received information; and signing the present electronic document with an electronic signature of the user, said signature containing the current date and time;
sending a predetermined signal in the encrypted form to other user, said signal containing information that acknowledges presence of the notice;
after the sending and respective reception of said signal, simultaneous changing the electronic notice sheet for an electronic letter decryption password;
receiving said decryption password to the personal cryptoprotective complex of the recipient, using said password to decrypt information received in the electronic letter at notice and outputting said information to the user;
receiving the electronic document being the notice-of-reception sheet of the electronic letter at notice to the personal cryptoprotective complex of the sender, decrypting said electronic document and inputting it to the user and recording a cryptogram of the notice sheet to the medium.

72. The method according to claim 68, further comprising:
inputting, in the personal cryptoprotective complex of the sender, a command to send an electronic letter at notice and inputting information, adding a number N generated by the random-number generator to the present information, separating said number by means of earlier inputted service symbols, inputting an individual number I of the personal cyrptoprotective complex of the addressee, producing a random number Z;
based on the inputted number I and the random number Z, encrypting the information, including the added random number N;
in accordance with said command, recording the random number Z to the PROM of the personal cryptoprotective complex and marking it with said random number N;
generating the electronic letter at notice from the inputted encrypted information and service information added thereto, separated with earlier inputted service symbols, containing the number that corresponds to the number N of information, and having a command included therein and indicating that the present information is an electronic letter at notice; outputting a copy of the encrypted electronic letter at notice for record to the medium;
transmitting the electronic letter at notice to a node computer, establishing a cryptoprotective communication session with a node cryptoprotective complex connected to the node computer, transmitting the random number Z to be stored in the node cryptoprotective complex;
receiving the electronic letter at notice from the node computer to the personal cryptoprotective complex of the addressee, decrypting the service information, finding the number N to be recorded to the PROM, and a command that the received encrypted information is an electronic letter at notice; and
outputting the present command to the user;
in accordance with said command and a command inputted by the recipient—to send a notice on reception of said message to the sender, generating the electronic document in the form of a preliminary inputted typical notice sheet, inputting the number N to said sheet, said number corresponding to a number of the received information; and signing the present electronic document with the electronic signature of the user, said signature containing the current date and time;
sending a predetermined signal in the encrypted form to the node cryptoprotective complex via the node computer, said signal containing information that acknowledges presence of the notice;
after the sending and respective reception of said signal, simultaneous changing the electronic notice sheet for the random number Z;
receiving the random number Z to the personal cryptoprotective complex of the recipient, outputting the individual number I of the personal cryptoprotective complex and generating a single-use decryption key of the basis of said numbers;
decrypting information received in the electronic letter at notice and outputting said information to the user;
receiving the electronic document being the notice-of-reception sheet of the electronic letter at notice to the personal cryptoprotective complex of the sender from the node cryptoprotective complex via the node computer, decrypting said electronic document and inputting it to the user and recording a cryptogram of the notice sheet to the medium.

73. A cassette for a personal cryptoprotective complex, intended for protection and storage of confidential and cryptographic information, comprising:
a microchip including a microprocessor capable of suppressing and masking self-microradiations and creating false microradiations,
a nonvolatile memory for storing encryption, decryption and information processing programs and an individual number of a cryptoprotective device,
a volatile memory being for storing a mother code and comprising a built-in accumulator,
a protective sheath of the microchip, connected to the accumulator and a protective sheath integrity monitor unit providing erase of information from the volatile memory at an authorized access from the outside, said protective sheath consisting of three layers wherein the inner and outer layers of the protective sheath are formed with light-reflecting surfaces faced each other, and a third, transparent layer enclosed there between, wherein the light-emitting microdiodes and microphotocells face to the outer light-reflecting layer, said protective sheath integrity monitor unit being intended to set a periodicity and a radiation doze of the light-emitting microdiodes, to measure power absorbed by the microphotocells, to compare the measured values to reference values, and at their non-coincidence to de-energize the volatile memory for destroying the mother code stored therein.

74. A cassette according to claim 73, wherein the microprocessor comprises additional parallel paths to supply signals compensating the microradiations of own signals of the microprocessor, and a generator for generating false microradiations in a frequency band of self-microradiations of the microprocessor.
